(19) United States
(12) Patent Application Publication
(10) Pub. No.: US 2017/0308849 A1
(43) Pub. Date: Oct. 26, 2017

(54) GENERATING NOTIFICATIONS USING LOGICAL GROUPINGS

(71) Applicant: United Parcel Service of America, Inc., Atlanta, GA (US)

(72) Inventors: Mike Roush, Milton, GA (US); Milin Shah, Cumming, GA (US); Robert J. Gillen, Johns Creek, GA (US)

(21) Appl. No.: 15/384,412

(22) Filed: Dec. 20, 2016

Related U.S. Application Data
(60) Provisional application No. 62/326,061, filed on Apr. 22, 2016.

(51) Int. Cl. G06Q 10/08; H04L 12/58

(52) U.S. Cl. CPC G06Q 10/0833; H04L 51/046

(57) ABSTRACT

Computer program products, methods, systems, apparatus, and computing entities for generating notifications/messages are provided. In one embodiment, logical groupings associated with items to be delivered are stored. The shipping data for the items can comprise item identifiers and logical grouping identifiers. By using a current logical grouping identifier, it can be determined when an item from a new logical grouping is being or has been delivered. Responsively, notifications/messages can be generated for the new logical grouping to indicate (a) a time window within which the items of the new logical grouping are expected to be delivered or (b) whether a pick-up can be made within the time window.

### CROSS-REFERENCE TO RELATED APPLICATIONS

This application claims priority to U.S. Provisional Application No. 62/326,061 filed Apr. 22, 2016, which is hereby incorporated herein in its entirety by reference.

### BACKGROUND

With an ever-increasing need for mobility and flexibility in item/shipment pick-up and item/shipment delivery contexts, new techniques and approaches are needed for accurate notifications regarding pick-ups and deliveries that have reduced memory and processing requirements to generate the notifications.

### BRIEF SUMMARY

In general, embodiments of the present invention provide methods, apparatus, systems, computing devices, computing entities, and/or the like for notifications/messages.

In accordance with one aspect, a method is provided. In one embodiment, the method comprises (1) for each of a first plurality of items, electronically storing shipping data comprising (a) a first logical grouping identifier corresponding to a first logical grouping with which each of the first plurality of items is associated and (b) a respective item identifier for each of the first plurality of items; (2) for each of a second plurality of items, electronically storing shipping data comprising (a) a second logical grouping identifier corresponding to a second logical grouping with which each of the second plurality of items is associated and (b) a respective item identifier for each of the second plurality of items; (3) electronically setting a current logical grouping identifier to the first logical grouping identifier; (4) responsive to receiving input that a particular item from the second plurality of items is to be delivered, determining whether the logical grouping identifier for the particular item is the same as the current logical grouping identifier; and (5) responsive to determining the logical grouping identifier for the particular item is not the same as the current logical grouping identifier, identifying the shipping identifiers associated with the second logical grouping.

In accordance with another aspect, a computer program product is provided. The computer program product may comprise at least one non-transitory computer-readable storage medium having computer-readable program code portions stored therein, the computer-readable program code portions comprising executable portions configured to (1) for each of a first plurality of items, electronically store shipping data comprising (a) a first logical grouping identifier corresponding to a first logical grouping with which each of the first plurality of items is associated and (b) a respective item identifier for each of the first plurality of items; (2) for each of a second plurality of items, electronically store shipping data comprising (a) a second logical grouping identifier corresponding to a second logical grouping with which each of the second plurality of items is associated and (b) a respective item identifier for each of the second plurality of items; (3) electronically set a current logical grouping identifier to the first logical grouping identifier; (4) responsive to receiving input that a particular item from the second plurality of items is to be delivered, determine whether the logical grouping identifier for the particular item is the same as the current logical grouping identifier; and (5) responsive to determining the logical grouping identifier for the particular item is not the same as the current logical grouping identifier, identify the shipping identifiers associated with the second logical grouping.

In accordance with yet another aspect, an apparatus comprising at least one processor and at least one memory including computer program code is provided. In one embodiment, the at least one memory and the computer program code may be configured to, with the processor, cause the apparatus to (1) for each of a first plurality of items, electronically store shipping data comprising (a) a first logical grouping identifier corresponding to a first logical grouping with which each of the first plurality of items is associated and (b) a respective item identifier for each of the first plurality of items; (2) for each of a second plurality of items, electronically store shipping data comprising (a) a second logical grouping identifier corresponding to a second logical grouping with which each of the second plurality of items is associated and (b) a respective item identifier for each of the second plurality of items; (3) electronically set a current logical grouping identifier to the first logical grouping identifier; (4) responsive to receiving input that a particular item from the second plurality of items is to be delivered, determine whether the logical grouping identifier for the particular item is the same as the current logical grouping identifier; and (5) responsive to determining the logical grouping identifier for the particular item is not the same as the current logical grouping identifier, identify the shipping identifiers associated with the second logical grouping.

In accordance with one aspect, a method is provided. In one embodiment, the method comprises (1) for each of a first plurality of items, electronically storing shipping data comprising (a) a first logical grouping identifier corresponding to a first logical grouping with which each of the first plurality of items is associated and (b) a respective item identifier for each of the first plurality of items; (2) electronically setting a current logical grouping identifier to the first logical grouping identifier; (3) receiving a pick-up request of an item for pick-up of an item by a carrier, the pick-up request comprising an address for the location of the pick-up; (4) determining whether the address for the location of the pick-up is associated with the current logical grouping; and (5) responsive to determining that the address for the location of the pick-up is associated with the current logical grouping, (a) identifying a planned time associated with the current logical grouping and (b) and providing a notification that the pick-up can be completed within the planned time.

In accordance with another aspect, a computer program product is provided. The computer program product may comprise at least one non-transitory computer-readable storage medium having computer-readable program code portions stored therein, the computer-readable program code portions comprising executable portions configured to (1) for each of a first plurality of items, electronically store shipping data comprising (a) a first logical grouping identifier corresponding to a first logical grouping with which each of the first plurality of items is associated and (b) a respective item identifier for each of the first plurality of items; (2) electronically set a current logical grouping identifier to the first logical grouping identifier; (3) receive a pick-up request of an item for pick-up of an item by a carrier, the pick-up request comprising an address for the location of the pick-up; (4) determine whether the address for the location of the pick-up is associated with the current logical grouping; and (5) responsive to determining that the address for the location of the pick-up is associated with the current logical grouping, (a) identify a planned time associated with the current logical grouping and (b) and provide a notification that the pick-up can be completed within the planned time.

In accordance with yet another aspect, an apparatus comprising at least one processor and at least one memory including computer program code is provided. In one embodiment, the at least one memory and the computer program code may be configured to, with the processor, cause the apparatus to (1) for each of a first plurality of items, electronically store shipping data comprising (a) a first logical grouping identifier corresponding to a first logical grouping with which each of the first plurality of items is associated and (b) a respective item identifier for each of the first plurality of items; (2) electronically set a current logical grouping identifier to the first logical grouping identifier; (3) receive a pick-up request of an item for pick-up of an item by a carrier, the pick-up request comprising an address for the location of the pick-up; (4) determine whether the address for the location of the pick-up is associated with the current logical grouping; and (5) responsive to determining that the address for the location of the pick-up is associated with the current logical grouping, (a) identify a planned time associated with the current logical grouping and (b) and provide a notification that the pick-up can be completed within the planned time.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of a system that can be used to practice various embodiments of the present invention.

FIG. 2 is a diagram of an information/data collection device that may be used in association with certain embodiments of the present invention.

FIG. 3 is a schematic of a carrier computing system in accordance with certain embodiments of the present invention.

FIG. 4 is a schematic of a customer computing entity in accordance with certain embodiments of the present invention.

FIGS. 5A, 5B, and 5C are flowcharts illustrating operations and processes that can be used in accordance with various embodiments of the present invention.

FIGS. 6-17 and 18A-18B are exemplary input and output produced in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

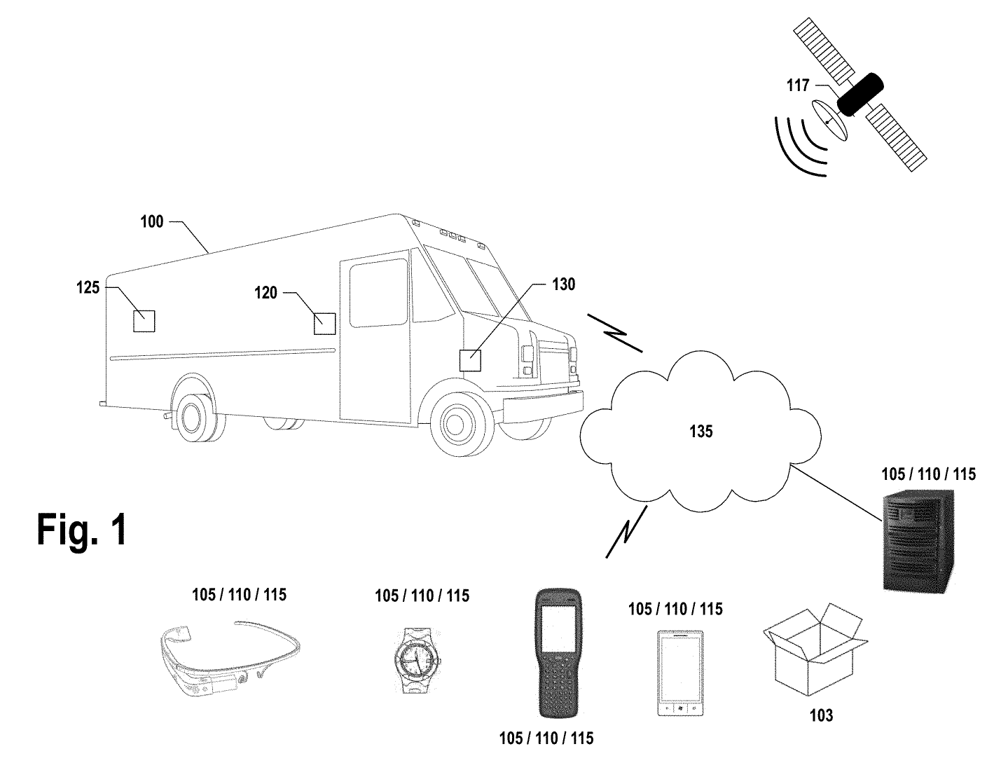

FIG. 1 provides an illustration of a system that can be used in conjunction with various embodiments of the present invention. As shown in FIG. 1, the system may include one or more vehicles 100, one or more items/shipments 103, one or more carrier computing systems 105, one or more customer computing entities 110, one or more carrier personnel computing entities 115, one or more Global Positioning System (GPS) satellites 117, one or more location sensors 120, one or more telematics sensors 125, one or more information/data collection devices 130, one or more networks 135, and/or the like. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities, the various embodiments are not limited to this particular architecture.

### 1. Exemplary Vehicle

In various embodiments, the term vehicle 100 is used generically. In one embodiment, a vehicle may be a carrier vehicle, such as a manned or an unmanned tractor, a truck, a car, a motorcycle, a moped, a Segway, a bicycle, a golf cart, a hand truck, a cart, a trailer, a tractor and trailer combination, a van, a flatbed truck, a vehicle, a drone, an aerial vehicle, an airplane, a helicopter, a barge, a boat, and/or any other form of object for moving or transporting people and/or items/shipments (e.g., one or more packages, parcels, bags, containers, loads, crates, items/shipments banded together, vehicle parts, pallets, drums, the like, and/or similar words used herein interchangeably). In one embodiment, each vehicle 100 may be associated with a unique vehicle identifier (such as a vehicle ID) that uniquely identifies the vehicle 100. The unique vehicle ID may include characters, such as numbers, letters, symbols, and/or the like. For example, an alphanumeric vehicle ID (e.g., “AS445” and/or “1G6AF5SX6D0125409”) may be associated with each vehicle 100. In another embodiment, the unique vehicle ID may be the license plate, registration number, or other identifying information/data assigned to the vehicle 100.

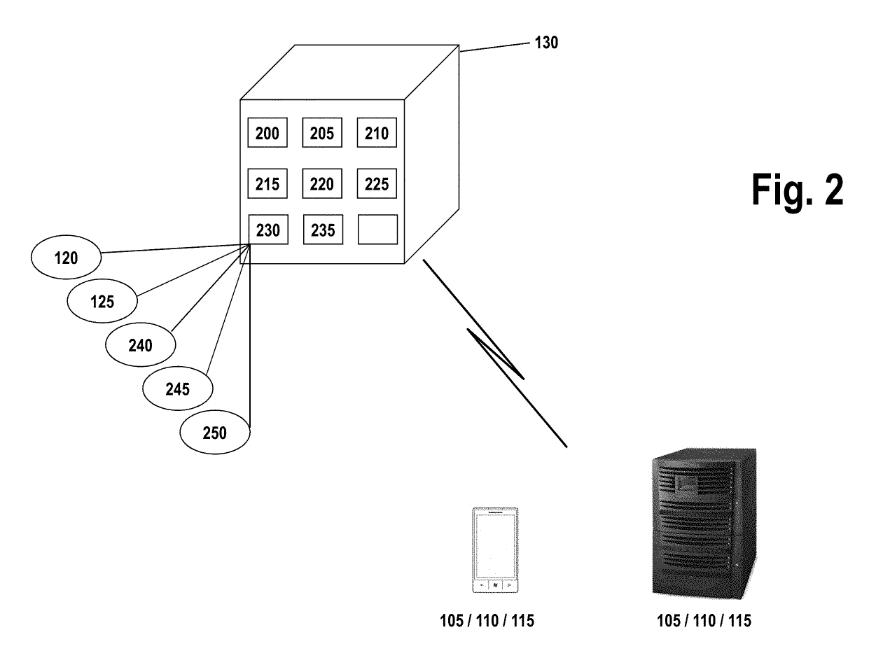

FIG. 1 shows one or more computing entities, devices, and/or similar words used herein interchangeably that are associated with the vehicle 100, such as an information/data collection device 130 or other computing entities. In general, the terms computing entity, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, items/devices, vehicles, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. FIG. 2 provides a block diagram of an exemplary information/data collection device 130 that may be attached, affixed, disposed upon, integrated into, or part of a vehicle 100. The information/data collection device 130 may collect telematics information/data (including location data) and transmit/send the information/data to various other computing entities via one of several communication methods.

In one embodiment, the information/data collection device 130 may include, be associated with, or be in wired or wireless communication with one or more processors 200 (various exemplary processors are described in greater detail below), one or more location-determining devices or one or more location sensors 120 (e.g., Global Navigation Satellite System (GNSS) sensors), one or more telematics sensors 125, one or more real-time clocks 215, a J-Bus protocol architecture, one or more electronic control modules (ECM) 245, one or more communication ports 230 for receiving telematics information/data from various sensors (e.g., via a CAN-bus), one or more communication ports 205 for transmitting/sending data, one or more RFID tags/sensors 250, one or more power sources 220, one or more information/data radios 235 for communication with a variety of communication networks, one or more memory modules 210, and one or more programmable logic controllers (PLC) 225. It should be noted that many of these components may be located in the vehicle 100 but external to the information/data collection device 130.

In one embodiment, the one or more location sensors 120, modules, or similar words used herein interchangeably may be one of several components in wired or wireless communication with or available to the information/data collection device 130. Moreover, the one or more location sensors 120 may be compatible with GPS satellites 117, such as Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the Decimal Degrees (DD); Degrees, Minutes, Seconds (DMS); Universal Transverse Mercator (UTM); Universal Polar Stereographic (CARRIER) coordinate systems; and/or the like. Alternatively, triangulation may be used in connection with a device associated with a particular vehicle 100 and/or the vehicle's operator and with various communication points (e.g., cellular towers or Wi-Fi access points) positioned at various locations throughout a geographic area to monitor the location of the vehicle 100 and/or its operator. The one or more location sensors 120 may be used to receive latitude, longitude, altitude, heading or direction, geocode, course, position, time, and/or speed information/data (e.g., referred to herein as telematics information/data and further described herein below). The one or more location sensors 120 may also communicate with a variety of computing entities.

As indicated, in addition to the one or more location sensors 120, the information/data collection device 130 may include and/or be associated with one or more telematics sensors 125, modules, and/or similar words used herein interchangeably. For example, the telematics sensors 125 may include vehicle sensors, such as engine, fuel, odometer, hubometer, tire pressure, location, weight, emissions, door, and speed sensors. The telematics information/data may include, but is not limited to, speed data, emissions data, RPM data, tire pressure data, oil pressure data, seat belt usage data, distance data, fuel data, idle data, and/or the like (e.g., referred to herein as telematics data). The telematics sensors 125 may include environmental sensors, such as air quality sensors, temperature sensors, and/or the like. Thus, the telematics information/data may also include carbon monoxide (CO), nitrogen oxides (NOx), sulfur oxides (SOx), Ethylene Oxide (EtO), ozone (O₃), hydrogen sulfide (H₂S) and/or ammonium (NH₄) data, and/or meteorological information/data (e.g., referred to herein as telematics data).

In one embodiment, the ECM 245 may be one of several components in communication with and/or available to the information/data collection device 130. The ECM 245, which may be a scalable and subservient device to the information/data collection device 130, may have information/data processing capability to decode and store analog and digital inputs from vehicle systems and sensors. The ECM 245 may further have information/data processing capability to collect and present telematics information/data to the J-Bus (which may allow transmission to the information/data collection device 130), and output standard vehicle diagnostic codes when received from a vehicle's J-Bus-compatible on-board controllers 240 and/or sensors.

As indicated, a communication port 230 may be one of several components available in the information/data collection device 130 (or be in or as a separate computing entity). Embodiments of the communication port 230 may include an Infrared information/data Association (IrDA) communication port, an information/data radio, and/or a serial port. The communication port 230 may receive instructions for the information/data collection device 130. These instructions may be specific to the vehicle 100 in which the information/data collection device 130 is installed, specific to the geographic area in which the vehicle 100 will be traveling, specific to the function the vehicle 100 serves within a fleet, and/or the like. In one embodiment, the information/data radio 235 may be configured to communicate with a wireless wide area network (WWAN), wireless local area network (WLAN), wireless personal area network (WPAN), or any combination thereof. For example, the information/data radio 235 may communicate via various wireless protocols, such as 802.11, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols (including Bluetooth low energy (BLE)), wireless universal serial bus (USB) protocols, and/or any other wireless protocol.

### 2. Exemplary Item

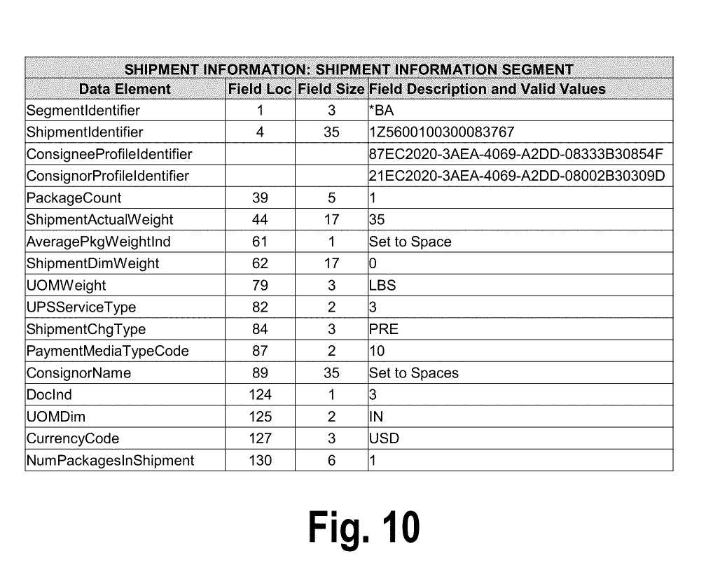

In one embodiment, an item/shipment 103 may be any tangible and/or physical object. In one embodiment, an item/shipment 103 may be or be enclosed in one or more packages, envelopes, parcels, bags, goods, products, containers, loads, crates, items/shipments banded together, vehicle parts, pallets, drums, the like, and/or similar words used herein interchangeably. In one embodiment, each item/shipment 103 may include and/or be associated with item/shipment information/data. Some exemplary item/shipment information/data is shown in FIGS. 10, 11, and 12. As will be recognized, the item/shipment information/data may include an item/shipment identifier. Such item/shipment identifiers may be represented as text, barcodes, tags, character strings, Aztec Codes, MaxiCodes, Data Matrices, Quick Response (QR) Codes, electronic representations, and/or the like. A unique item/shipment identifier (e.g., 123456789) may be used by the carrier to identify and track the item/shipment 103 as it moves through the carrier's transportation network. Further, such item/shipment identifiers can be affixed to items/shipments 103 by, for example, using a sticker (e.g., label) with the unique item/shipment identifier printed thereon (in human and/or machine readable form) or an RFID tag with the unique item/shipment identifier stored therein. Such items/shipments may be referred to as “connected” items/shipments 103 and/or “non-connected” items/shipments 103.

In one embodiment, connected items/shipments 103 include the ability to determine their locations and/or communicate with various computing entities. This may include the item/shipment 103 being able to communicate via a chip or other devices, such as an integrated circuit chip, RFID technology, Near Field Communication (NFC) technology, Bluetooth technology, Wi-Fi technology, and any other suitable communication techniques, standards, or protocols with one another and/or communicate with various computing entities for a variety of purposes. Connected items/shipments 103 may include one or more components that are functionally similar to those of the carrier computing system 105 and/or the customer computing entity 110 as described below. For example, in one embodiment, each connected item/shipment 103 may include one or more processing elements, one or more display device/input devices (e.g., including user interfaces), volatile and non-volatile storage or memory, and/or one or more communications interfaces. In this regard, in some example embodiments, an item/shipment 103 may communicate send “to” address information/data, received “from” address information/data, unique identifier codes, location information/data, status information/data, and/or various other information/data (all are generically referred to herein as item/shipment information/data.

In one embodiment, non-connected items/shipments 103 do not typically include the ability to determine their locations and/or might not be able communicate with various computing entities or are not designated to do so by the carrier. The location of non-connected items/shipments 103 can be determined with the aid of other appropriate computing entities. For example, non-connected items/shipments 103 can be scanned (e.g., affixed barcodes, RFID tags, and/or the like) or have the containers or vehicles in which they are located scanned or located. As will be recognized, an actual scan or location determination of an item/shipment 103 is not necessarily required to determine the location of an item/shipment 103. That is, a scanning operation might not actually be performed on a label affixed directly to an item/shipment 103 or location determination might not be made specifically for or by an item/shipment 103. For example, a label on a larger container housing many items/shipments 103 can be scanned, and by association, the location of the items/shipments 103 housed within the container are considered to be located in the container at the scanned location. Similarly, the location of a vehicle 100 transporting many items/shipments can be determined, and by association, the location of the items/shipments 103 being transported by the vehicle 100 are considered to be located in the vehicle 100 at the determined location. These can be referred to as “logical” scans/determinations or “virtual” scans/determinations. Thus, the location of the items/shipments 103 is based on the assumption they are within the container or vehicle 100, despite the fact that one or more of such items/shipments 103 might not actually be there.

### 3. Exemplary Carrier Computing System

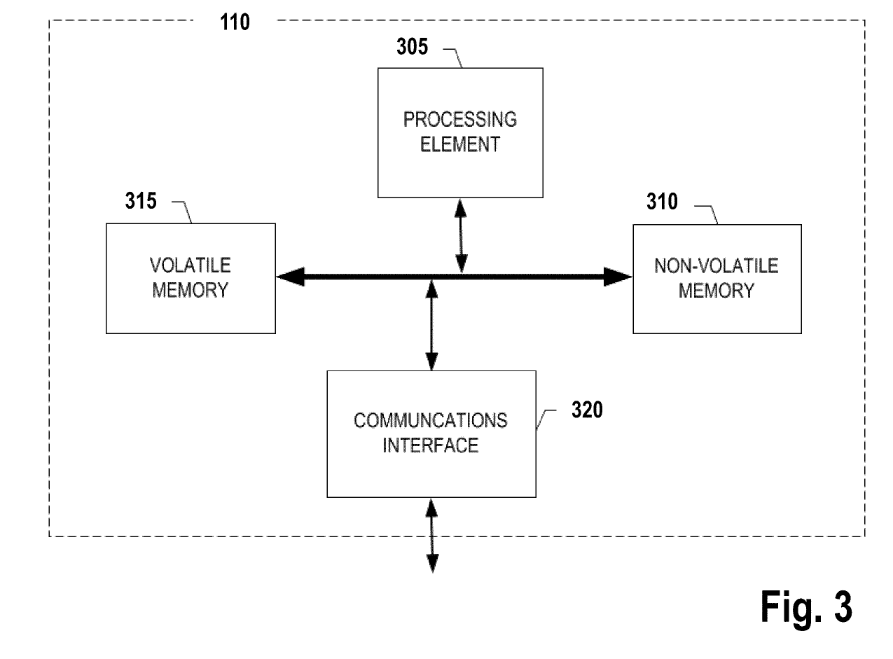

FIG. 3 provides a schematic of a carrier computing system 105 according to one embodiment of the present invention. A carrier may be a traditional carrier, such as United Parcel Service, FedEx, DHL, courier services, the United States Postal Service (USPS), Canadian Post, freight companies (e.g. truck-load, less-than-truckload, rail carriers, air carriers, ocean carriers, etc.), and/or the like. However, a carrier may also be a nontraditional carrier, such as Amazon, Google, Uber, ride-sharing services, crowd-sourcing services, and/or the like. A carrier computing system 105 may be located at a carrier location and/or the like, such as a carrier service center, will call, kiosk, drop-box, locker system, hub, facility, and/or the like. In general, the terms computing entity, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, RFID tags, ear pieces, scanners, televisions, dongles, cameras, wristbands, wearable items/devices, items/devices, vehicles, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the carrier computing system 105 may also include one or more communications interfaces 320 for communicating with various computing entities, such as by communicating data, content, information, and/or similar terms used herein interchangeably that can be transmitted, received, operated on, processed, displayed, stored, and/or the like. The carrier computing system 105 can also be used for making, receiving, and/or transferring payments. Payments may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. Such payments may be made using a variety of techniques and approaches, including through NFC technologies such as PayPass, Android Beam, Bluetooth low energy (BLE), and various other contactless payment systems. Further, such payment technologies may include PayPal Beacon, Booker, Erply, Leaf, Apple Pay, Leapset, Micros, PayPal Here, Revel, ShopKeep, TouchBistro, Vend, and/or the like.

As shown in FIG. 3, in one embodiment, the carrier computing system 105 may include or be in communication with one or more processing elements 305 (also referred to as processors, processing circuitry, and/or similar terms used herein interchangeably) that communicate with other elements within the carrier computing system 105 via a bus, for example. As will be understood, the processing element 305 may be embodied in a number of different ways. For example, the processing element 305 may be embodied as one or more complex programmable logic devices (CPLDs), microprocessors, multi-core processors, coprocessing entities, application-specific instruction-set processors (ASIPs), and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present invention when configured accordingly.

In one embodiment, the carrier computing system 105 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 310 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably may refer to a structured collection of records or information/data that is stored in a computer-readable storage medium, such as via a relational database, hierarchical database, and/or network database.

In one embodiment, the carrier computing system 105 may further include or be in communication with volatile media (also referred to as volatile storage, memory, memory storage, memory circuitry and/or similar terms used herein interchangeably). In one embodiment, the volatile storage or memory may also include one or more volatile storage or memory media 315 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 305. Thus, the databases, database instances, database management system entities, data, applications, programs, program modules, scripts, source code, object code, byte code, compiled code, interpreted code, machine code, executable instructions, and/or the like may be used to control certain aspects of the operation of the carrier computing system 105 with the assistance of the processing element 305 and operating system.

As indicated, in one embodiment, the carrier computing system 105 may also include one or more communications interfaces 320 for communicating with various computing entities, such as by communicating data, content, information, and/or similar terms used herein interchangeably that can be transmitted, received, operated on, processed, displayed, stored, and/or the like.

Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the carrier computing system 105 may be configured to communicate via wireless external communication networks using any of a variety of protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol. Although not shown, the carrier computing system 105 may include or be in communication with one or more input elements, such as a keyboard input, a mouse input, a touch screen/display input, audio input, pointing device input, joystick input, keypad input, and/or the like. The carrier computing system 105 may also include or be in communication with one or more output elements (not shown), such as audio output, video output, screen/display output, motion output, movement output, and/or the like.

As will be appreciated, one or more of the carrier computing system's 105 components may be located remotely from other carrier computing system 105 components, such as in a distributed system. Furthermore, one or more of the components may be combined and additional components performing functions described herein may be included in the carrier computing system 105. Thus, the carrier computing system 105 can be adapted to accommodate a variety of needs and circumstances.

### 4. Exemplary Customer Computing Entity

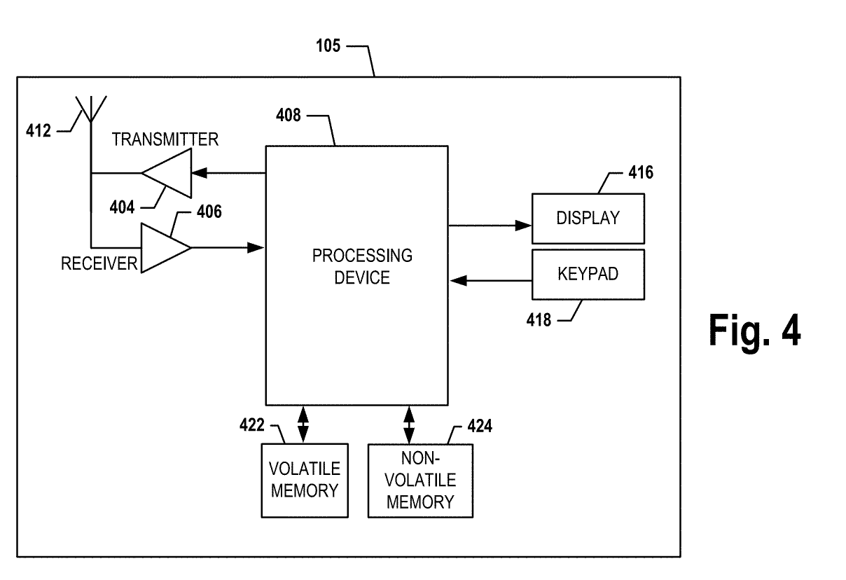

A customer may be an individual, a family, a family member, a company, an organization, an entity, a department within an organization, a representative of an organization and/or person, and/or the like. Depending on the context, customers may be consignors and/or consignees. Accordingly, the term customer may refer to both consignors and/or consignees interchangeably. FIG. 4 provides an illustrative schematic representative of a customer computing entity 110 that can be used in conjunction with embodiments of the present invention. In one embodiment, the customer computing entities 110 may include one or more components that are functionally similar to those of the carrier computing system 105 and/or as described below. As shown in FIG. 4, a customer computing entity 110 can include an antenna 412, a transmitter 404 (e.g., radio), a receiver 406 (e.g., radio), and a processing element 408 that provides signals to and receives signals from the transmitter 404 and receiver 406, respectively.

The signals provided to and received from the transmitter 404 and the receiver 406, respectively, may include signaling information/data in accordance with an air interface standard of applicable wireless systems to communicate with various entities, such as vehicles 100, carrier computing systems 105, and/or the like. In this regard, the customer computing entity 110 may be capable of operating with one or more air interface standards, communication protocols, modulation types, and access types. More particularly, the customer computing entity 110 may operate in accordance with any of a number of wireless communication standards and protocols. In a particular embodiment, the customer computing entity 110 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the customer computing entity 110 can communicate with various other entities using concepts such as Unstructured Supplementary Service information/data (USSD), Short notification/message Service (SMS), Multimedia Messaging Service (MMS), Dual-Tone Multi-Frequency Signaling (DTMF), and/or Subscriber Identity Module Dialer (SIM dialer). The customer computing entity 110 can also download changes, add-ons, and updates, for instance, to its firmware, software (e.g., including executable instructions, applications, program modules), and operating system. For example, in one embodiment, the customer computing entity 110 may store and execute a carrier application to assist in communicating with the carrier and/or for providing location services regarding the same.

According to one embodiment, the customer computing entity 110 may include location determining aspects, devices, modules, functionalities, and/or similar words used herein interchangeably. For example, the customer computing entity 110 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the customer computing entity's 105 position in connection with a variety of other systems, including cellular towers, Wi-Fi access points, and/or the like. Similarly, the customer computing entity 110 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, NFC transmitters, and/or the like. These indoor positioning aspects can be used in a variety of settings to determine the location of someone or something to within inches or centimeters.

The customer computing entity 110 may also comprise a user interface (that can include a display 416 coupled to a processing element 408) and/or a user input interface (coupled to a processing element 408). For example, the user interface may be an application, browser, user interface, dashboard, webpage, and/or similar words used herein interchangeably executing on and/or accessible via the customer computing entity 110 to interact with and/or cause display of information. The user input interface can comprise any of a number of devices allowing the customer computing entity 110 to receive data, such as a keypad 418 (hard or soft), a touch display, voice/speech or motion interfaces, scanners, readers, or other input device. In embodiments including a keypad 418, the keypad 418 can include (or cause display of) the conventional numeric (0-9) and related keys (#, *), and other keys used for operating the customer computing entity 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the customer computing entity can collect contextual information/data as part of the telematics data.

The customer computing entity 110 can also include volatile storage or memory 422 and/or non-volatile storage or memory 424, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the customer computing entity 110.

### 5. Exemplary Carrier Personnel Computing Entity

As will be recognized, carrier personnel computing entities 115 can be operated by various parties, including a carrier pick-up/delivery person and/or operators of vehicles 100. For example, a user may be a carrier pick-up/delivery person picking up items/shipments from and/or delivering items/shipments to customers. Moreover, a carrier personnel computing entity 115 may include one or more components that are functionally similar to those of the carrier computing system 105 and/or the customer computing entity 110. For example, in one embodiment, each carrier personnel computing entity 115 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, and/or similar words used herein interchangeably executing on and/or accessible via the carrier personnel computing entity 115 to interact with and/or cause display of information/data from various other computing entities. As will be recognized, these architectures and descriptions are provided for exemplary purposes only and are not limiting to the various embodiments.

### III. EXEMPLARY SYSTEM OPERATION

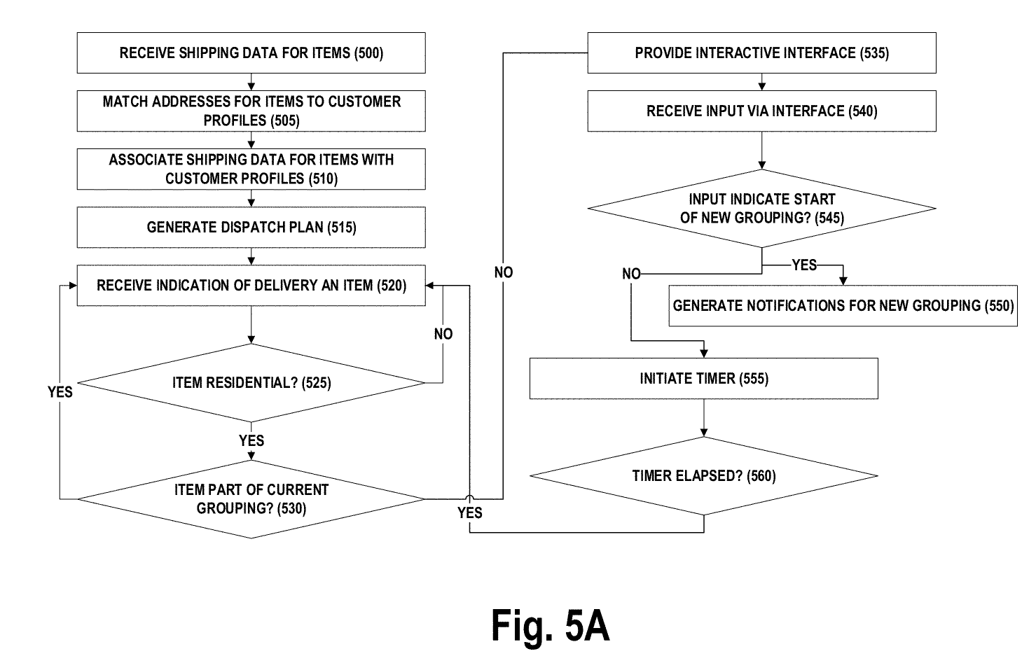

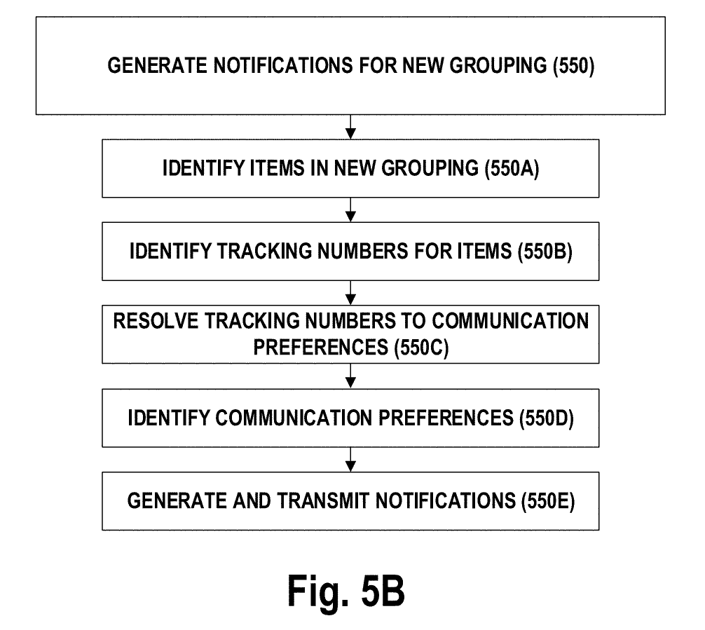

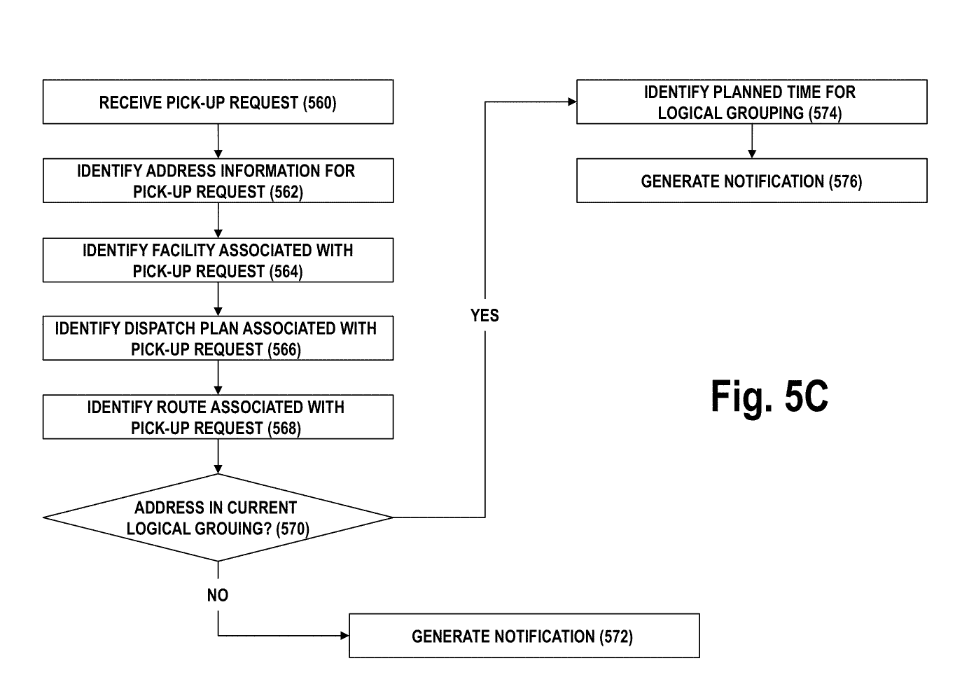

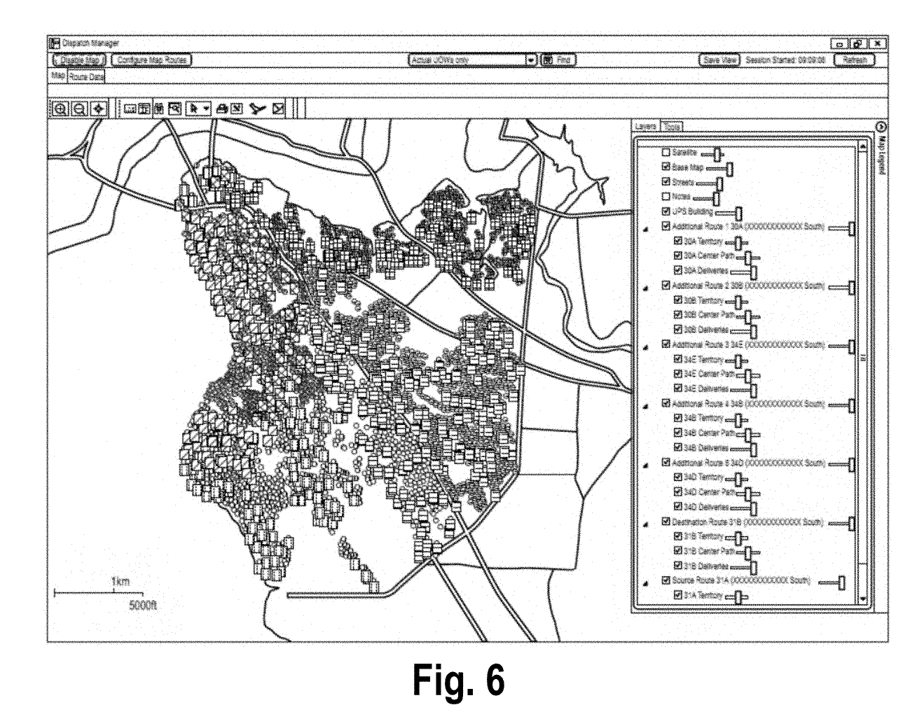

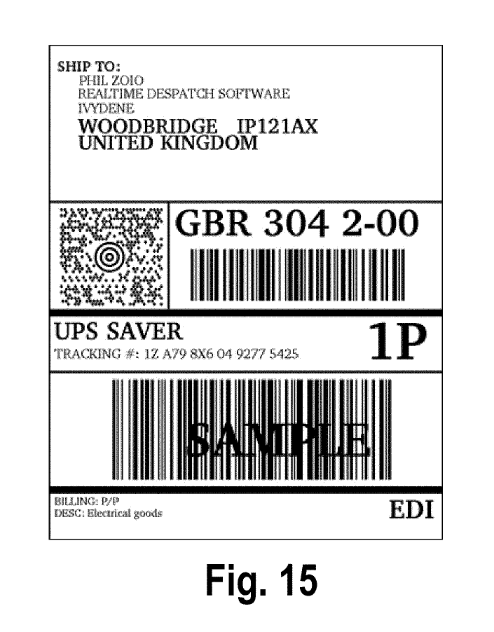

Reference will now be made to FIGS. 5A-5B, 6-17 and 18A-18B. FIGS. 5A, 5B, and 5C are flowcharts illustrating operations and processes that can be used in accordance with various embodiments of the present invention. FIGS. 6-17 and 18A-18B are exemplary input and output produced in accordance with various embodiments of the present invention.

### 1. Registration

In one embodiment, to receive pick-up and/or delivery notifications/messages, a customer may need to be registered or verified for notification/messaging services. In one embodiment, this may include being part of a customer pick-up, delivery, and/or returns program. As will be recognized, a customer (e.g., consignor, consignee, third party, and/or the like) may be an individual, a family, a company, an organization, an entity, a department within an organization, a representative of an organization and/or person, and/or the like. To register, a customer (e.g., a customer or customer representative operating a consignee computing device 110 or consignor computing device 120) may access a webpage, application, dashboard, browser, or portal of a carrier, such as United Parcel Service of America, Inc. (UPS).

In one embodiment, as part of the enrollment/registration process, the customer (e.g., operating a consignee computing device 110 or consignor computing device 120) may be requested to provide biographic and/or geographic information/data by the carrier system 100 (e.g., via the registration module 270). Such information/data may be manually input or provided by allowing access to other accounts, such as Facebook, Gmail, Twitter, PayPal, and/or the like. For instance, the customer may provide the customer's name, such as a first name, a last name, a company name, an entity name, and/or an organization name. The customer (e.g., consignor or consignee) may also provide any aliases associated with the customer. For instance, if the customer (e.g., consignor or consignee) were an individual named Joseph Brown, the customer (e.g., consignor or consignee) may provide Joe Brown or Joey Brown as aliases.

The customer (e.g., consignor or consignee) may also provide one or more physical addresses associated with the customer (e.g., street address, city, state, postal code, and/or country) to the carrier system 100. For instance, Joseph Brown's primary residential address of 105 Main Street, Atlanta, Ga. 30309, USA, may be provided to the carrier system 100. Further, one or more secondary residential addresses may also be provided to the carrier system 100 for association with Mr. Brown's account and profile, such as 71 Lanier Islands, Buford, Ga. 30518, USA. As will be recognized, the residential addresses may include weekend residences, family member residences visited by the customer, and/or the like. Additionally, the customer (e.g., consignor or consignee) may also provide one or more business addresses associated with the customer (e.g., street address, city, state, postal code, and/or country) to the carrier system 100. For example, Mr. Brown may have a primary business address of 1201 West Peachtree Street, Atlanta, Ga. 30309, USA. One or more secondary business addresses may also be provided to the carrier system 100 for association with Mr. Brown's account and profile, such as 101 South Tryon Street, Charlotte, N.C. 28280, USA; 950 F Street, NW, Washington, D.C. 20004, USA; and 90 Park Avenue, New York, N.Y. 10016, USA. As will be recognized, the business addresses may include various office locations for a single enterprise, multiple office locations for various enterprises, and/or the like. As will be recognized, the customer (e.g., consignor or consignee) may provide other biographic and/or geographic information/data to adapt to various needs and circumstances.

In one embodiment, once the carrier system 100 receives the necessary biographic and/or geographic information/data from the customer, the carrier system 100 may perform one or more validation operations. For example, the carrier system 100 may determine whether the primary address (and/or other addresses) in the specified country or postal code is eligible for a customer pick-up, delivery, and/or returns programs. The carrier system 100 may also determine whether the primary address (and/or other addresses) is valid, e.g., by passing the primary address through one or more address cleansing and/or standardization systems. The carrier system 100 may perform a variety of fraud prevention measures as well, such as determining whether the customer (e.g., consignor or consignee) or one of the customer's addresses has been “blacklisted” from customer pick-up, delivery, and/or returns programs. As will be recognized, a variety of other approaches and techniques can be used to adapt to various needs and circumstances.

In one embodiment, the carrier system 100 may create a customer profile for the customer via the enrollment/registration process. Accordingly, the carrier system 100 may create and store various customer profiles (e.g., via database 240). In addition to at least the information/data described above, a customer profile may include one or more corresponding usernames and passwords. As will be recognized, each of the physical addresses may be associated with the customer's profile.

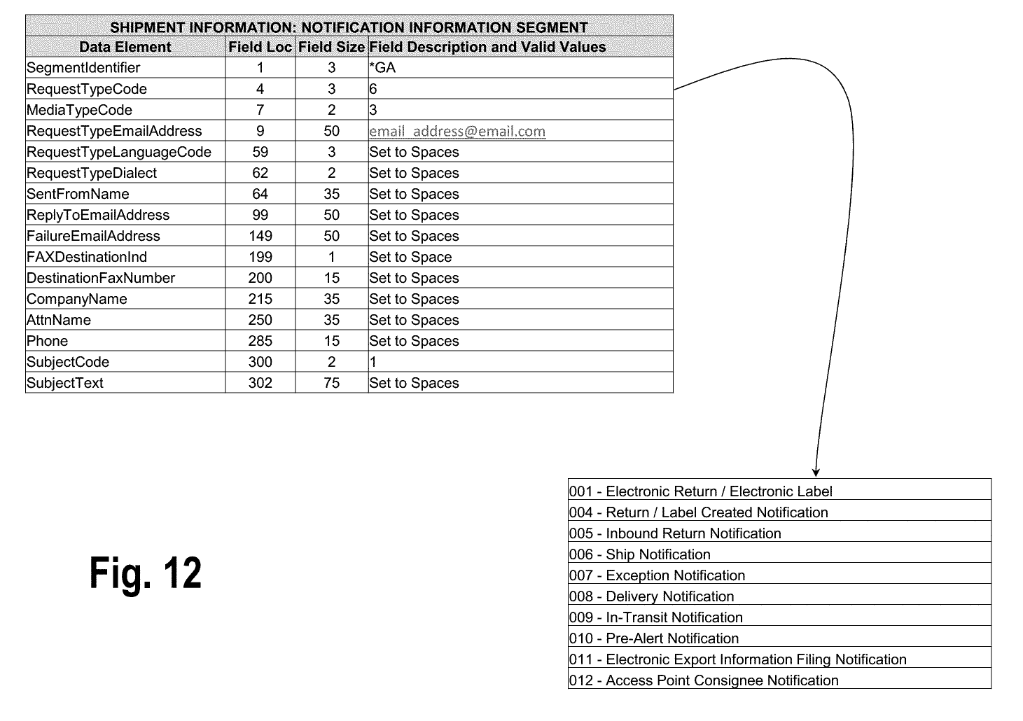

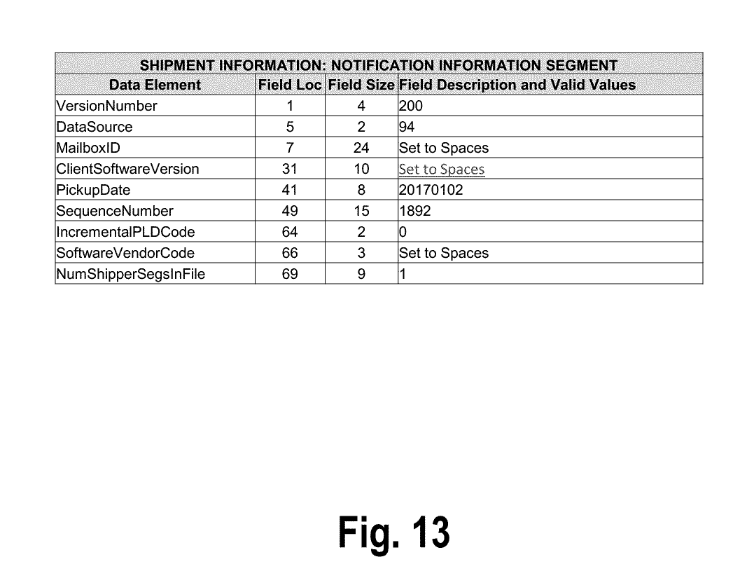

In one embodiment, in addition to the physical addresses, the customer (e.g., operating a customer computing device 110/120) may also input, request, or be automatically generated and assigned a “virtual address.” The virtual address can be a combination of alphanumeric characters to identify a customer or customer profile. The virtual address can be stored by the carrier system 100 in association with the customer's profile. For example, Joseph Brown (e.g., operating a customer computing device 110/120) may input a request for a unique virtual address such as BigBrown8675309 or any other unique virtual address. In another embodiment, the carrier system 100 may automatically generate and assign a unique virtual address for the customer, such as assigning virtual address 1XR457RS7 to Joseph Brown. Such virtual addresses can be used by customers who do not want to (a) provide their physical addresses to merchants or other third parties, (b) have their physical addresses printed on labels placed on the exterior of items, and/or (c) the like. For instance, this may enable a consignor to ship a package using only BigBrown8675309 or 1XR457RS7 as the destination address (e.g., virtual address) using the appropriate carrier. Upon induction of the package into the carrier's transportation and logistics network, carrier personnel can read (e.g., manually or with the aid of a device) the virtual address on the item/shipment (e.g., BigBrown8675309 or 1XR457RS7), look up the appropriate physical delivery address for the item/shipment based on the consignee's profile (e.g., search for the customer profile associated with the virtual address), and route the item/shipment accordingly (including the use of automatic service schedules). In certain embodiments, the item/shipment may be routed only using the virtual address. That is, each item/shipment the item/shipment is handled by carrier personnel, a mobile station 105 (in communication with the carrier system 100) operated by the carrier personnel can cause display of the appropriate handling or routing instructions while masking the actual physical delivery address. In other embodiments, however, once the item/shipment with the virtual address is inducted into the carrier's transportation and logistics network, carrier personnel may place a label on the item/shipment that indicates the physical delivery address (e.g., based on an address associated with the profile and/or automatic service schedule)—see FIGS. 12 and 13. Such virtual address concepts are disclosed in U.S. Pat. No. 8,108,321, which is hereby incorporated in its entirety by reference. Both physical addresses and virtual addresses may be referred to herein interchangeably as “addresses.”

In addition to the virtual address, the carrier system 100 may also generate and store an internal customer identifier in association with the customer profile, such as a global unique identifier (GUID) or a universally unique identifier (UUID). For instance, in one embodiment, the customer identifier may be a 128-bit value displayable as hexadecimal digits with groups separated by hyphens. By way of example, the customer identifier for Joseph Brown may be 21EC2020-3AEA-4069-A2DD-08002B30309D. In one embodiment, a customer identifier may be used to uniquely identify a customer profile. In another embodiment, a customer identifier may be used to uniquely identify a given address (e.g., physical address or virtual address) associated with a customer profile. In such an embodiment, if a customer profile is associated with four addresses, the carrier system 100 may generate and store four customer identifiers in association with the customer profile (or use one customer identifier for all the addresses for the customer). The customer identifier may also be stored in association with item/shipment information/data for an item/shipment to associate the item/shipment (and its shipping data) with the (a) correct customer (e.g., customer profile) and/or (b) correct address for a customer. For instance, the item/shipment information/data for all shipments corresponding to Joseph Brown's customer profile may be appended with the customer identifier created for Joseph Brown. In various embodiments, using this approach allows items/shipments (and their shipping data) to be linked to appropriate customer profiles. Thus, when Joseph Brown accesses his account, he can view all of his shipments (e.g., those shipments with item/shipment information/data appended with his customer identifier (or other identifier)). Similarly, any actions for an item/shipment or customer can be passed to the item/shipment information/data for the item/shipment (including carrying out automatic service schedules). In other words, the customer identifier appended to the item/shipment information/data resolves to the corresponding customer profile/account and/or address. The item/shipment information/data may have multiple customer identifiers appended—one or more customer identifiers for the consignor and one or more customer identifiers for the consignee.

In one embodiment, a customer profile may correspond to one or more customer pick-up, delivery, and/or returns programs. For instance, a customer (e.g., operating a customer computing device 110/120) may subscribe to a specific customer pick-up, delivery, and/or returns program. In one embodiment, there may be several customer pick-up, delivery, and/or returns programs from which to choose, such as a free customer pick-up, delivery, and/or returns program and a premium customer pick-up, delivery, and/or returns program. As will be recognized the customer pick-up, delivery, and/or returns program may have a variety of benefits. For example, the customer pick-up, delivery, and/or returns program may allow customers to have access to certain features, e.g., pick-up and delivery alerts, approximate pick-up and delivery times, pick-up and delivery confirmations, change pick-up and delivery options, electronically authorize the release of an item, and/or route items/shipments to will call. Similarly, the customer pick-up, delivery, and/or returns program (e.g., requiring a fee) may allow customers to have access to certain features—such as the ability to route items/shipments to other retail locations, reschedule pick-ups and deliveries, request that items/shipments be delivered to another address, and/or provide instructions for pick-up or delivery. Payments for such fees may be in a variety of forms, such as via debit card, credit card, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. As will be recognized, these features are provided for illustrative purposes and are not limiting to embodiments of the present invention. Moreover, a variety of other approaches and techniques can be used to adapt to various needs and circumstances.

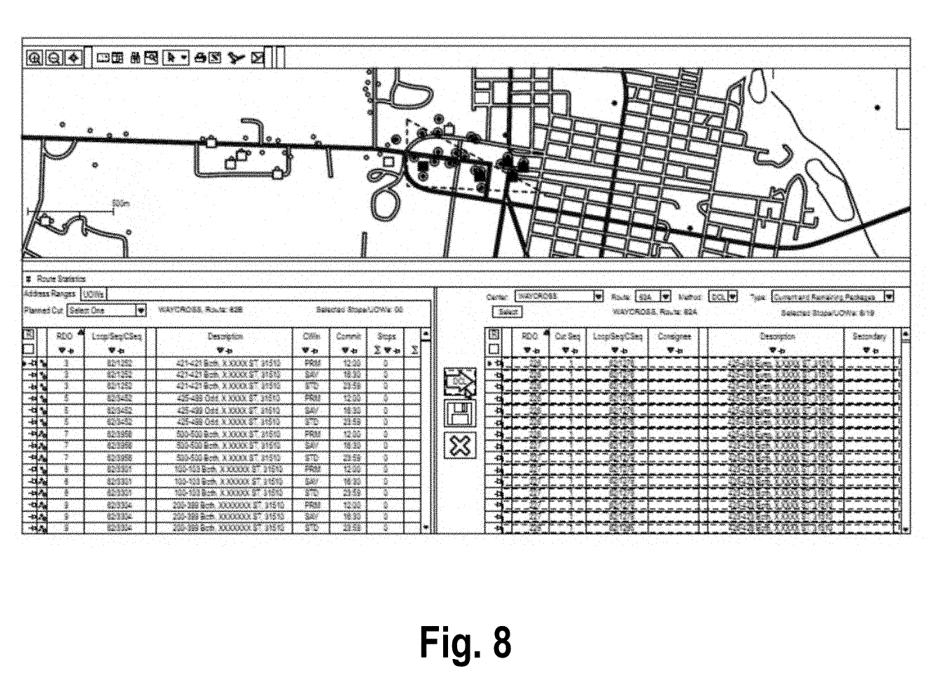

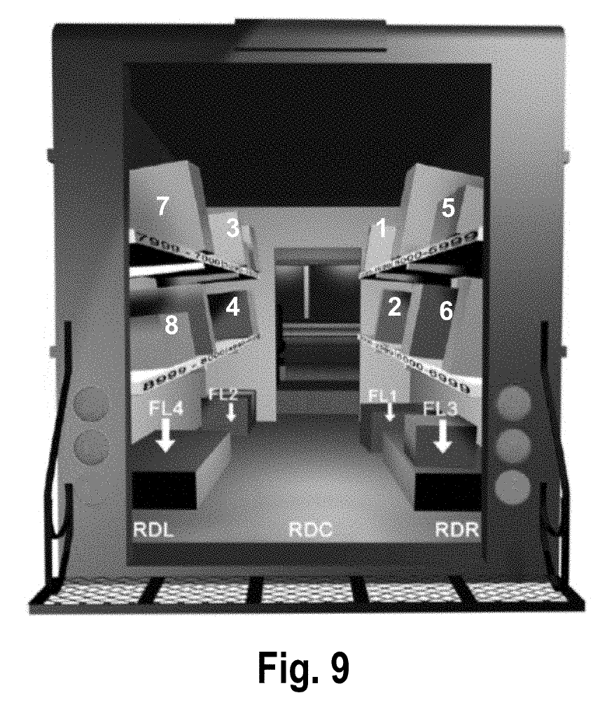

In one embodiment, once a customer profile has been created by the carrier system 100, the customer (e.g., operating a customer computing device 110/120) can provide various preferences associated with the customer delivery program to the carrier system 100 via an interface, for example. For instance, as shown in FIGS. 8 and 9, the customer (e.g., operating a customer computing device 110/120) can provide a variety of preferences, such communication preferences, service schedule preferences, delivery preferences, delivery options, and/or delivery instructions. The customer (e.g., operating a customer computing device 110/120) may also update any information/data through the appropriate interface (e.g., browser, dashboard, webpage, application).

### 2. Initiating a Shipment and Shipment Data

In one embodiment, the process may begin with the initiation of a shipment by the carrier system 100 generating and/or receiving item/shipment information/data for one or more items/shipments. The customer may initiate the shipping process by entering identifying information/data into the carrier system 100. In various embodiments, the customer (e.g., a customer or customer representative operating a consignee computing entity 110 or consignor computing entity 120) may access a webpage, application, dashboard, browser, or portal of a carrier. After the customer is identified (e.g., based on his or her profile), the customer may initiate a shipment. In various embodiments, the carrier system 100 may then provide a user interface (e.g., browser, dashboard, application) for the customer to provide item/shipment information/data which includes certain details regarding the item/shipment. In various embodiments, the item/shipment information/data may include a name, street address, city, state, postal code, country, telephone number, and/or the like for both the consignor and the consignee. In various embodiments, the user interface may comprise a fillable form with fields including ship-from information/data and ship-to information/data. In various embodiments, some of the information/data fields may be pre-populated. For example, if the customer logged into a registered account/profile, the address information/data entered during registration may be pre-populated in certain information/data fields. In some embodiments, the customer may also have a digital address book associated with the account comprising address information/data for possible ship-to and/or ship-from information/data. The customer may be able to select certain ship-to and/or ship-from information/data from the address book for the associated shipment.

In one embodiment, after the carrier system 100 receives the ship-to and/or ship-from information/data from the customer, the carrier system 100 may perform one or more validation operations. For example, the carrier system 100 may determine whether the primary address (and/or other addresses) in the specified country or postal code is eligible for a pick-up or delivery. The carrier system 100 may also determine whether the primary address (and/or other secondary addresses) is valid, e.g., by passing the primary address through one or more address cleansing or standardization systems. The carrier system 100 may perform a variety of fraud prevention measures as well, such as determining whether the customers (or one of the delivery addresses) have been “blacklisted” from customer pick-up and/or delivery. As will be recognized, a variety of other approaches and techniques can be used to adapt to various needs and circumstances.

In addition to ship-to and/or ship-from information/data, the item/shipment information/data may also include service level information/data. The service level options may be, for example, Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like.

In one embodiment, the carrier system 100 (a) may be provided item/shipment characteristics and attributes in the item/shipment information/data and/or (b) may determine item/shipment characteristics and attributes from the item/shipment information/data. The characteristics and attributes may include the dimensions, weight, shipping classifications, planned movements in the carrier's transportation and logistics network, planned times, and/or the like for various items/shipments. For example, the length, width, height, base, radius, and weight can be received as input information/data and/or can be determined or collected by various carrier systems. For example, sensors or cameras may be positioned to capture or determine the length, width, height, and weight (including dimensional weight) of an item/shipment as it moves along the conveyor, moves in or out of loading bay, is carried by a lift truck, is transported through the carrier's transportation and logistics network, and/or the like.

In one embodiment, with such information/data, the carrier system 100 can determine/identify the cube/volume for each item/shipment. The units of measurement for the equations may be established so that the size produced by the determinations is in cubic feet, or cubic inches, or any other volumetric measure. In one embodiment, after determining the cube/volume for an item/shipment (and/or making various other determinations), the carrier system 100 can apply a classification to the item/shipment based at least in part on the cube/volume. The classifications may include (1) size category one items/shipments, (2) size category two items/shipments, (3) size category three items/shipments, and/or (4) size category four items/shipments. By way of example, (1) size category one items/shipments may be defined as being within >0 and ≦2 cubic feet, (2) size category two items/shipments may be defined as being within >2 and ≦4 cubic feet, (3) size category three items/shipments may be defined as being within >4 and ≦6 cubic feet, and/or (4) size category four items/shipments may be defined as being over >6 cubic feet. As will be recognized, a variety of other approaches and techniques can be used to adapt to various needs and circumstances.

In one embodiment, the carrier system 100 may assign or associate one or more planned times for each item/shipment—along with a planned time for specific activities for the item/shipment, each stop of a route, each route, and/or the like. A planned time may be the time for handling (e.g., sorting, re-wrapping, loading, unloading, inspecting, picking up, delivering, labeling, over-labeling, and/or the like) an item/shipment. In one embodiment, each item/shipment, each activity, each stop of a route, each route, and/or the like may have or be associated with total planned times and/or additive planned times. The planned times may be based on historical information/data, such as average planned times.

As indicated, a planned time may comprise a total planned time for an item/shipment, an activity, a stop of a route, a route, and/or the like. The total planned time may comprise various additive planned times (both of which are referred to herein interchangeably as planned times). The planned times may be based on a variety of factors or parameters. For example, the planned time may be based on the cube/volume and/or weight of the item/shipment—e.g., it may take more time to move an item/shipment that weighs 11.52 pounds from a conveyor belt than to move an item/shipment weighing 0.32 pounds from the same conveyor belt. Further, the planned time factors and/or parameters may also contemplate or include the type of item/shipment, such as whether the item/shipment requires special handling. The planned time factors and/or parameters may also contemplate the service level of and/or activities to be carried out for the item/shipment. Based on the factors and parameters, for instance, the carrier system 100 may store, have access to, and/or may forecast/estimate planned times for sorting, handling, conveying, scanning, picking up, delivering, and/or the like various items/shipments. For purposes of illustration and not of limitation, for sorting an item/shipment from a belt conveyor to a position in a full length trailer, (1) a size category one item/shipment may be assigned or associated with a 1 second additive planned time, (2) a size category two item/shipment assigned a 1.5 second additive planned time, and so forth. Similarly, for a load operation from a warehouse to a vehicle, for instance, (1) each size category one item/shipment may be assigned or associated with 5 seconds of planned time, (2) each size category two item/shipment may be assigned or associated with 7 seconds of planned time, (3) each size category three item/shipment may be assigned or associated with 10 seconds of planned time, and (4) each size category four item/shipment may be assigned or associated with 20 seconds of planned time. Moreover, (1) each special handling category one item/shipment may be assigned or associated with 25 seconds of additive planned time, (2) each special handling category two item/shipment may be assigned or associated with 45 seconds of additive planned time, and (3) each special handling category three item/shipment may be assigned or associated with 33 seconds of additive planned time. The additive planned times may also be specific to carrier equipment: unload systems, load systems, sortation systems, vehicles, re-wrap systems, weighing systems, inspection systems, tools, and/or any other suitable systems. Thus, the additive planned times may vary for different types of systems (e.g., unload conveyor A, unload conveyor B) since the times for handling specific tasks associated with the different systems may vary. Additionally, some of the additive planned times may vary based on different types of vehicles since a storage area of the vehicles may vary based on the size of the vehicles. For instance, it may take longer or shorter times to walk to locations of the storage area and access walls, shelves, and/or the like of the storage area. In this example, the carrier system 100 may determine/identify additive planned times associated with setup of conveyors (e.g., an unload conveyor). Further, there may be an additive planned time for loading the item/shipment onto a vehicle or conveyor, sorting the item/shipment at a hub or other center, re-wrapping and over-labeling the item/shipment, scanning and walking the item/shipment from a delivery vehicle to its final delivery destination, and/or the like.

The additive planned times may also be specific to vehicles (which also may be referred to herein as equipment) used in load, unload, pick-up, and/or delivery operations of items/shipments, as well as one or more bundles/containers. For instance, the carrier system 100 may determine the number of items/shipments that may be loaded on or unloaded from the trailer or truck within a given time period based on the sizes of trucks/trailers (e.g., 40 foot trailers, 50 foot trailers) and/or the like. As such, in response to identifying a selected vehicle from which to unload and/or load items, the carrier system 100 may determine/identify additive planned times (e.g., an unload system, a load system) based in part on the size of the trailer/truck and/or equipment being used. As will be recognized, longer length trailers/trucks may require greater additive planned times relative to shorter length trailers, for example, to walk off items/shipments (e.g., packages), and may, but need not, require longer conveyors, which may require more setup time than shorter conveyors. Additionally, in some embodiments, various size category one items/shipments may be stored in one or more bundles/containers (e.g., bags, tote boxes, and/or the like). As such, in an instance in which the carrier system 100 may determine that a bundle/container includes size category one items, the carrier system 100 may assign an additive planned time to the bundle/container which may decrease or increase the handling time for size category one items/shipments for a given load.

In one embodiment, the carrier system 100 can determine/identify a total planned time for handling, transporting, warehousing, sorting, loading, unloading, re-wrapping, inspecting, picking up, delivering, and/or the like an item/shipment from ingestion into the carrier's transportation and logistics network through to delivery at its final delivery destination. Additionally, the carrier system 100 can determine planned times for different legs or activities for a given item/shipment (e.g., a planned time for pick-up or delivery of an item/shipment). In one embodiment, the total planned time may be an estimated time irrespective of the various potential additive planned times.

Continuing with the above example, for the size category four item/shipment with a cube of 2.315 cubic feet weighing 15 pounds, the carrier system 100 may assign a total planned time for picking up an item/shipment from Corporation ABC's Distribution warehouse in Orlando, Fla., 123 Springfield Road, Norcross, Ga. 30092. The total planned time may be estimated based on historical information/data for similar items/shipments and/or be the sum of various activities to be carried out for the item (including picking up and delivering the item/shipment). For instance, the total planned time for an item may be 0.0352778 hours (127 seconds). This can represent the total allowed time for picking up, handling, conveying, inspecting, unloading, loading, re-wrapping, delivering, and/or the like the item/shipment as it is transported through the carrier's transportation and logistics network. In this example, the driver is allowed or allotted 0.0007869 hours (2.83284 seconds) to pick up the item/shipment. As will be recognized, total planned times and additive planned times can be stored in association with various item/shipment information/data. Using this information/data, the carrier system 100 can determine and assign total planned times and additive planned times for dispatch plans, routes, logical groupings, stops on routes, items/shipments, and/or the like.

In one embodiment, the item/shipment information/data may also include tracking information/data (of various “tracking events”) corresponding to the location of the item/shipment in the transportation and logistics network. To determine and reflect an item's movement, an item/shipment identifier associated with the item/shipment may, for example, be scanned or otherwise electronically read at various points as the item/shipment is transported through the carrier's transportation and logistics network. As indicated, these events may be referred to as tracking events. In one embodiment, the latest or most-recent tracking events (e.g., tracking information/data) can associate the item/shipment with the particular origin entity, destination entity, bundle/container, vehicle, employee, location, facility, and/or the like.

In some embodiments, customers (e.g., operating a consignee computing entity 110 or consignor computing entity 120) can customize and/or provide communication preferences regarding items/shipments to be picked up from or delivered to the customers (see FIG. 13). For example, the communication preferences may provide customers with the ability to request notifications/messages for items/shipments before the carrier attempts to pick up or deliver items/shipments (e.g., prior to the first delivery attempt by the carrier) and/or after items/shipments have been picked up or delivered.

In some embodiments, a customer (e.g., operating a consignee computing entity 110 or consignor computing entity 120) can identify one or more communication formats for communicating with the customer. The communication formats may include text notifications/messages (e.g., Short notification/message Service (SMS) and/or Multimedia Messaging Service (MMS), email notifications/messages, voice notifications/messages, video notification/message (e.g., YouTube, the Vine), picture notification/message (e.g., Instagram), social media notification/message (e.g., private social media created internally for entities, business social media (e.g., Yammer, SocialCast), or public social media (e.g., Facebook, Instagram, Twitter)), and/or a variety of other notifications/messages in various communication formats. In addition to identifying one or more communication formats, the customer (e.g., operating a customer computing entity 110/120) can identify the corresponding electronic destination addresses to be used in providing information/data regarding items/shipments to be picked up from or delivered to the customer. For instance, for text notifications/messages, the customer may provide one or more cellular phone numbers. For email notifications/messages, the customer may provide one or more email addresses. And for voice notifications/messages, the customer may provide one or more cellular or landline phone numbers. Additionally, in one embodiment, validation operations can be performed with respect to each input electronic destination address—to ensure their accuracy. As will be recognized, a variety of other types of electronic destination addresses can be used to adapt to various needs and circumstances.

In various embodiments, customers (e.g., operating a consignee computing entity 110 or consignor computing entity 120) may identify/define time periods/frames in which the notifications/messages should be transmitted to the customer providing information/data regarding items/shipments to be delivered. In such cases, the notifications/messages can serve as a reminder to the customer that an item/shipment is being delivered. The one or more notifications/messages and/or delivery notifications/messages may be triggered based on preferences identified by the customer (e.g., 48 hours before delivery, 24 hours before delivery, 8 hours before delivery, 4 hours before delivery, 2 hours before delivery, 1 hour before delivery, 30 minutes before delivery, 15 minutes before delivery, when the driver enters a geofence or other designated area, and/or the like). In some cases, the notifications/messages can be defined as countdown messages. For example, the carrier system 100 may send a series of notifications/messages based on logical groupings in accordance with triggering events (e.g., using logical grouping identifiers). Similarly the time periods/frames may be after delivery for confirmation of delivery or even after an unsuccessful delivery attempt to the customer. In such a case, the customer may define where and how notifications/messages regarding such unsuccessful delivery attempts should be made as part of the communication preferences. As will be recognized, the carrier system 100 can store communication preferences for providing information/data in association with the customer profiles or may store the information/data in association with the item/shipment information/data. Moreover, the communication preferences may apply to the customer profile globally, to selected customer addresses, to groups of items, and/or on an item-by-item basis. In some embodiments, the carrier system 100 may allow the customer to establish preferences for the shipment using the user interface when the item/shipment information/data is being provided. As explained in greater detail below, these preferences may be used as notification/message criteria for determining when to send messages/notifications in association with the items/shipments being delivered.

### 3. Customer and Item/Shipment Matching

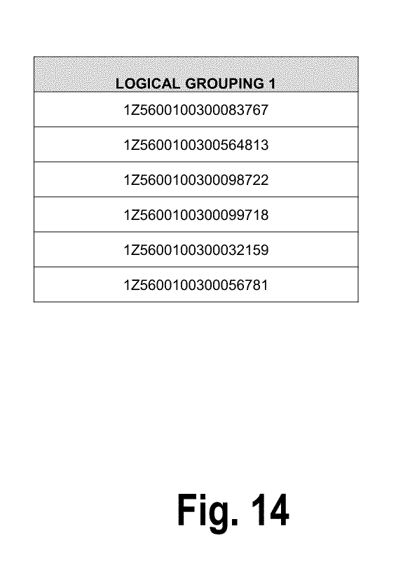

In one embodiment, one or more items/shipments can be received by the carrier to be transported in the carrier's transportation and logistics network—as indicated in Block 500 of FIG. 5A. Upon receipt of an item/shipment, carrier personnel or equipment can read (e.g., scan, interrogate, communicate with, and/or the like) the item/shipment 103. By reading the label (see FIG. 14), RFID tag, and/or the like associated with the item/shipment, item/shipment information/data for the item/shipment can be received by the carrier systems and/or related entities/devices. As will be recognized, the initial read of the item/shipment can be used to identify item/shipment information/data—such as consignee information/data, consignor information/data, address information/data, contents information/data, unique item/shipment identifier information/data, service level information/data, profile information/data, and/or the like.

In one embodiment, the carrier system 100 can use the item/shipment information/data to identify one or more customer profiles corresponding to the item/shipment. As described, each customer profile may include one or more physical addresses or virtual addresses associated with the customer. Thus, when the carrier system 100 receives item/shipment information/data (or a portion of shipping data) for an item/shipment, the carrier system 100 can determine whether the item/shipment corresponds to any customers enrolled/registered for a customer pick-up, delivery, and/or returns program. In particular, the carrier system 100 can parse the address (e.g., physical delivery address or the virtual address) and use the parsed address of the intended recipient (e.g., consignee or customer) in the item/shipment information/data for an item/shipment to identify (a) any customer profiles with a substantially similar physical delivery address or (b) a customer profile that matches the virtual address (Block 505 of FIG. 5A). For example, if the item/shipment information/data of an item/shipment indicates that the physical delivery address of the intended recipient is 105 Main St., Atlanta, Ga. 30309, the carrier system 100 may identify Joseph Brown's customer profile as corresponding to the item/shipment even though the address in Joseph Brown's profile is 105 Main Street, Atlanta, Ga. 30309, USA. In other words, in making such determinations, the carrier system 100 can accommodate variations for a given address. Similarly, the item/shipment information/data can be matched to the consignor's profile to provide electronic access to the consignor as well. As will be recognized, the carrier system 100 may be configured to compensate for various discrepancies.

In one embodiment, as a secondary measure for matching physical addresses to customer profiles, the carrier system 100 can use the delivery name of the intended recipient (e.g., consignee or customer) in the item/shipment information/data to confirm that the identified customer profile is correct. To do so, the carrier system 100 may compare the delivery name of the intended recipient in the item/shipment information/data to the primary name and/or any aliases in the identified customer profile. If the names are substantially similar, the carrier system 100 can confirm that the identified customer profile is correct. By way of example, if the item/shipment information/data indicates that the delivery name of the intended recipient is Joe Brown and Joseph Brown listed Joe as a first name alias, the carrier system 100 could confirm Joseph Brown's customer profile as corresponding to the item. As will be recognized, a variety of other approaches and techniques can be used to identify a customer profile corresponding to at least one item/shipment to be delivered by the carrier.

In another embodiment, the carrier system 100 can use the virtual address of the intended recipient (e.g., consignee or customer) in the item/shipment information/data for an item/shipment to identify the appropriate customer profile. For example, if the item/shipment information/data of an item/shipment indicates that the virtual address of the intended recipient is BigBrown8675309 (or 1XR457RS7), for example, the carrier system 100 may identify Joseph Brown's customer profile as corresponding to the item. As will be recognized, a variety of other approaches and techniques can be used to adapt to various needs and circumstances.

In one embodiment, after identifying the appropriate customer profile for an item, the carrier system 100 can associate the item/shipment information/data with the customer profile (Block 510 of FIG. 5A). In certain embodiments, this may include appending the item/shipment information/data for the corresponding item/shipment 103 with the appropriate customer identifier. For instance, the item/shipment information/data for all shipments corresponding to Joseph Brown's customer profile may be appended with the customer identifier (21EC2020-3AEA-4069-A2DD-08002B30309D) created for Joseph Brown. In various embodiments, using this approach allows items/shipments (and their shipping data) to be linked to appropriate customer profiles. Thus, when Joseph Brown accesses his account, he can view all of his shipments (e.g., those shipments with item/shipment information/data appended with 21EC2020-3AEA-4069-A2DD-08002B30309D). Similarly, any actions for an item/shipment or customer can be passed to the item/shipment information/data for the item/shipment (including carrying out automatic service schedules).

### 4. Logical Grouping Notifications

In addition to tracking items/shipments as they progress through a carrier's transportation and delivery network, the carrier system 100 can create/generate dispatch plans for carrying out the pick-up and/or delivery of items/shipments (e.g., work or units of work) to one or more serviceable points (Block 515). Dispatch plans are well known and are used daily by various carriers. In general, dispatch plans are groups of routes planned to be dispatched together along with their associated delivery and pick-up assignments. Dispatch plans may also indicate how each route should be loaded. FIGS. 6, 7, and 8 includes various territories, routes, serviceable points associated with a territory (e.g., geographic area) or route, and assigned pick-ups and deliveries for serviceable points for the same. A route is generally a grouping of address ranges for serviceable points with associated service levels assigned to a single service provider (e.g., carrier delivery personnel). Each route usually includes a trace, which is a predefined path through a deliverable territory within a loop defined by a sequence number. A delivery order listing then is a listing of address ranges for serviceable points that follows the trace for the route to visit perform the assigned pick-ups and/or deliveries for serviceable points. Through an appropriate interface, dispatch plans can be compared against alternative dispatch plans to load balance and otherwise adjust the various dispatch plans for a given geographic area, service center, route, and/or the like. U.S. Pat. No. 7,624,024 entitled Systems and Methods for Dynamically Updating a Dispatch Plan, filed Apr. 18, 2005 provides a general description of dispatch plans and how these plans may be generated and updated. This may include dynamically updating dispatch plans to add, remove, or update pick-ups and/or deliveries for serviceable points. U.S. Pat. No. 7,624,024 is incorporated herein in its entirety by reference.

So that the items/shipments can be readily accessed in the vehicle 100 based on the delivery order listing, each item/shipment can be assigned a load/storage position in the delivery vehicle. FIG. 9 identifies 15 exemplary load/storage positions: 1, 2, 3, 4, 5, 6, 7, 8, FL1 (floor 1), FL2 (floor 2), FL3 (floor 3), FL4 (floor 4), RDL (rear door left), RDC (rear door center), and RDR (rear door right). In one embodiment, each load/storage position may be associated with a sequence number. For instance, each item/shipment may be assigned a sequence number between X001-X999 (a number within the sequence range) based upon the load/storage position. For example, for an item/shipment assigned to load/storage position 1, the item/shipment may also be assigned a sequence number between 1001-1999 to indicate where on the load/storage position the item/shipment should be placed (e.g., 1538). In an embodiment in which 1500 indicates the midpoint of the shelf (e.g., load/storage position), sequence numbers 1001-1499 may indicate where on the shelf the item/shipment should be placed in relation to the midpoint (how far to the left). Similarly, sequence numbers 1501-1999 may also indicate where on the shelf (e.g., load/storage position) the item/shipment should be placed in relation to the midpoint (how far to the right). The same can occur for each load/storage position by assigning a sequence range and/or a sequence number to each item/shipment that is associated with the corresponding load/storage position: 1001-1999, 2001-2999, 3001-3999, 4001-4999, 5001-5999, 6001-6999, 7001-7999, 8001-8999, FL1001-FL1999, FL2001-FL2999, FL3001-FL3999, FL4001-FL4999, RDL001-RDL999, RDC001-RDC999, and RDR001-RDR999.

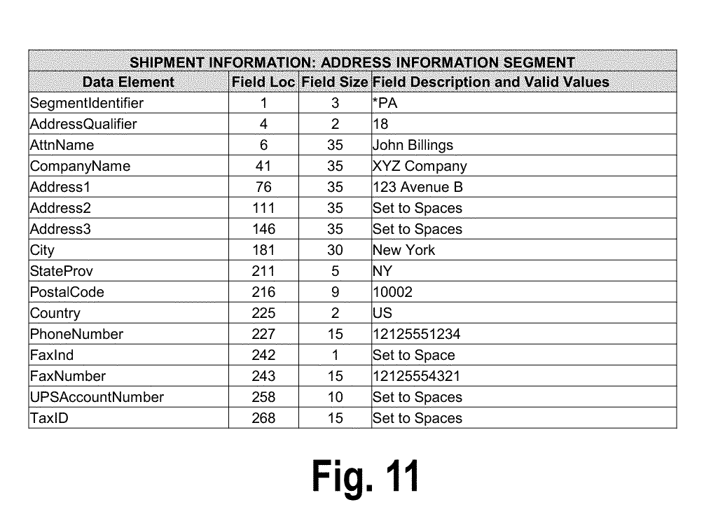

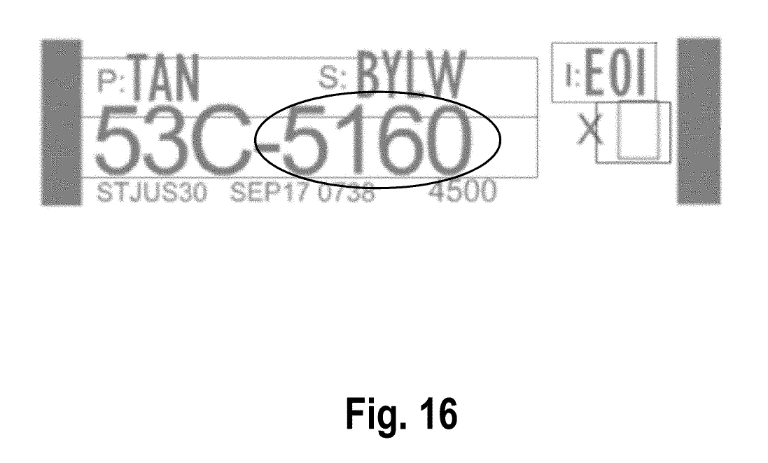

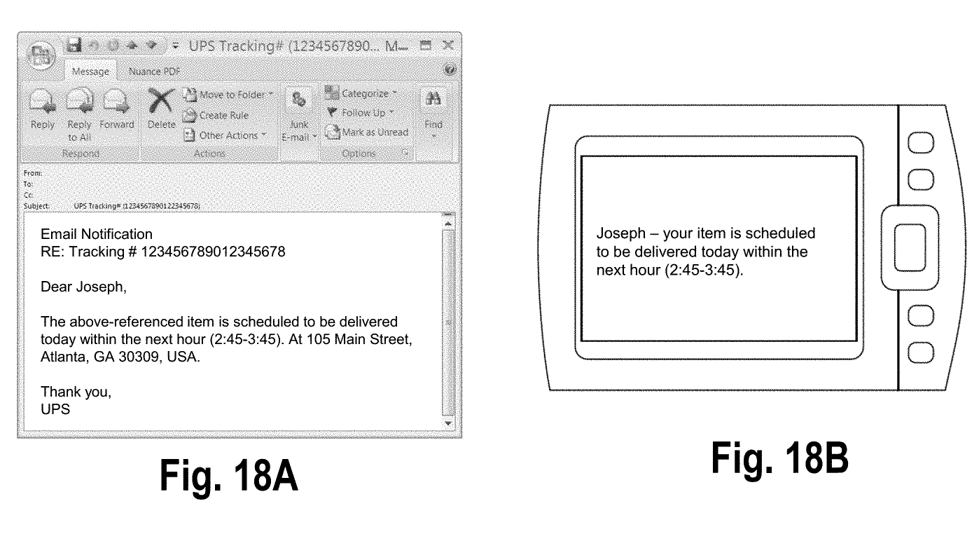

In one embodiment, the load/storage position, sequence number, and/or sequence range assigned to each item/shipment can be stored in association with the corresponding item/shipment information/data (see FIG. 13). The load/storage position can be provided via an interface, printed on a pre-load label to assist in loading the vehicle (see FIG. 16), and/or used in through a variety of other techniques and approaches. In one embodiment, the load/storage position, sequence number, and/or sequence range (e.g., 4001-4299) can be a logical grouping. A logical group may comprise a plurality of items/shipments that are to be delivered within a planned time (e.g., an estimated time period/frame of one another, such as 15 minutes, 1 hour, 2 hours, 4 hours, day, and/or the like). For instance, logical groupings may be based on routes, route portions, neighborhood names, zip codes, zip code+4, geographic areas, longitude and latitude ranges, geocodes, geographic descriptors, zones of confidence, geofences, and/or the like. As will be recognized, in one embodiment, each route may comprise one or more logical groupings and/or logical grouping identifiers. Each logical grouping may correspond to a specific planned time (e.g., estimated delivery time or window). For instance, a logical grouping may be associated with planned time of 15 minutes, 30 minutes, 1 hour, 2 hours, and/or the like for delivering all of the items/shipments in the logical grouping. The estimated delivery window may indicate the estimated amount of time to deliver all items of the logical grouping. For instance, if the planned time for the logical grouping is 1 hour, the notifications/messages can indicate that the items/shipments for the logical grouping will be delivered within the next hour from that point. That is, the estimated delivery window or time can be used to indicate when or within what time from the corresponding items/shipments will be delivered (see FIGS. 18A and 18B). If the current time is 1:00 pm EST and the planned time is 1 hour, the estimated delivery window for all items/shipments will be 1:00 pm EST to 2:00 pm EST. The logical groupings can also be stored in association with the item/shipment information/data (see FIG. 14 comprising a listing of the item/shipment identifiers associated with the logical grouping). In another embodiment, a specific field or portion of a field may already be designated as a logical grouping identifier. For example, the logical grouping identifier may be a portion of the shipment identifier (see FIG. 10), all or a portion of a zip code field (see FIG. 11), a load/storage position, a route, a route portion, all or a portion of a sequence number (see FIG. 13), a geographic descriptor, and/or the like. By using such logical groupings, embodiments of the present invention reduce the memory and processing requirements needed to generate the notifications by handling the processing for multiple items based on logical groups.

With the logical grouping identifiers, each item/shipment can be associated with a variety identifiers: a virtual address identifier (e.g., 1XR457RS7), a customer identifier (e.g., 21EC2020-3AEA-4069-A2DD-08002B30309D), an item/shipment identifier (e.g., 1Z-A79-8X6-04-9277-5425), a logical grouping identifier, and/or the like. As will be recognized, any one of these identifiers can resolve to the corresponding customer's profile to identify the corresponding communication preferences to generate and transmit notifications/messages to customers.

In one embodiment, the logical groupings and/or logical grouping identifiers can be used to generate notifications/messages corresponding to the items/shipments for the corresponding logical grouping. For instance, when the first item of a shelf or neighborhood is about to be delivered or has been delivered, an appropriate computing entity can generate and transmit notifications/messages to the customers with items that will be delivered as part of that logical grouping (e.g., the rest of the shelf or neighborhood). The following example describes an embodiment in which the storage/load position, sequence range, and/or the sequence number comprises the logical grouping and/or logical grouping identifier. But as will be recognized, a variety of other approaches and techniques can be used to adapt to various other circumstances.

In one embodiment, a variety of computing entities (e.g., vehicles 100, items/shipments 103, carrier computing systems 105, carrier personnel computing entities 115, and/or the like) can determine or receive input that an item/shipment is about to be delivered, is being delivered, or has just been delivered. For instance, in one embodiment, the carrier personnel computing entity 115 is configured to receive input (e.g., via the user interface) that indicates a variety of service dynamics, such as delivery-related or vehicle-related activities or occurrences. For example, in various embodiments, the user interface is configured to permit a driver to indicate the following service dynamics: (a) that a delivery stop has commenced (e.g., by pressing a button indicating that the driver has arrived at a delivery location and commenced the delivery process, scanning or interrogating an item/shipment), (b) that a delivery stop has ended (e.g., by pressing a button indicating that the driver has completed the delivery and is now leaving the delivery location), (c) that a particular bill of lading and its associated freight or packages have been picked up or delivered (e.g., by entering or scanning a tracking number or code, or otherwise identifying one or more bills of lading associated with freight or packages that have been picked up or delivered), (d) the number of units picked up or delivered at a stop (e.g., by manually entering a numerical value), (e) the weight of packages or freight picked up or delivered at a stop (e.g., by manually entering a numerical value), (f) that a lunch or break period has commenced or ended (e.g., by pressing a button indicating that the start or stop of a break or lunch), (g) that a particular delay encountered by a driver has commenced or ended (e.g., by entering a code or otherwise identifying a type of delay that a driver has encountered—such as waiting for freight, caught in traffic, fueling a vehicle, waiting at train tracks, waiting at security, waiting for bill of lading—and pressing a button indicating that the identified delay has started or stopped), (h) that the driver has begun a work day and is on the clock (e.g., at a shipping hub and before starting the vehicle 100), (i) that the driver has ended a work day and is off the clock, (j) that the driver and vehicle have entered a particular area (e.g., the property of a shipping hub, a designated delivery area or other work area), and/or (k) that the driver and vehicle have exited a particular area (e.g., the property of a shipping hub, a designated delivery area or other work area).

In one embodiment, in response to receiving input indicating that a delivery is about to occur or has occurred, the carrier personnel computing entity 115 may capture service information/data and/or item/shipment information/data in a computer readable format (Block 520 of FIG. 5A). After receiving input capturing the service information/data and/or item/shipment information/data, an appropriate computing entity (e.g., vehicles 100, items/shipments 103, carrier computing systems 105, carrier personnel computing entities 115, and/or the like) can determine whether the item is a “residential” item/shipment (e.g., an item/shipment being delivered to a residential location) or a “commercial” item/shipment (e.g., an item/shipment being delivered to a commercial location)—Block 525 of FIG. 5A. The operation may be carried out using a field in the item/shipment information/data, verifying the address of the intended recipient, based on the item/shipment identifier, and/or the like. As will be recognized, this operation is optional. Thus, in certain embodiments only residential deliveries are configured to generate and transmit notifications/messages. In other embodiments, all deliveries can be configured to generate and transmit notifications/messages for all items/shipments (regardless of whether they are residential or commercial items/shipments).

Regardless of the embodiment, the appropriate computing entity (e.g., vehicles 100, items/shipments 103, carrier computing systems 105, carrier personnel computing entities 115, and/or the like) can also determine whether the item/shipment information/data is part of the current logical grouping (Block 530 of FIG. 5A). For the first delivery for the day (or other time period, such as shifts or after breaks), the appropriate computing entity will determine that the item/shipment is not part of the current logical grouping as it is the first logical grouping being delivered for the day or time period/frame (e.g., the current logical grouping value is null until it is set by the first delivery of the day or time period). Once the current logical grouping value has been set for the day (or time period), the appropriate computing entity can store an indicator of the current logical grouping based on the last item/shipment delivered. Correspondingly, each time the carrier personnel computing entity 115 (or other appropriate computing entity) records a stop as being completed (e.g., an item as being delivered), the carrier personnel computing entity 115 can store the logical grouping of that item/shipment (e.g., the most recently delivered item/shipment) as the current logical grouping. For subsequent items/shipments, the appropriate computing entity (e.g., vehicles 100, items/shipments 103, carrier computing systems 105, carrier personnel computing entities 115, and/or the like) can compare the logical grouping for the item/shipment that is about to be or has been delivered with the logical grouping that is indicated as being the current logical grouping. To do so, an appropriate computing entity identifies the current logical grouping and the logical grouping for the item/shipment that is about to be or has been delivered.

Responsive to determining that an item/shipment is part of the current logical grouping, the appropriate computing entity does not take any action. Rather, the appropriate computing entity (e.g., vehicles 100, items/shipments 103, carrier computing systems 105, carrier personnel computing entities 115, and/or the like) waits for input indicating that a different item/shipment is about to be or has been delivered (e.g., the process returns to Block 520 of FIG. 5A).

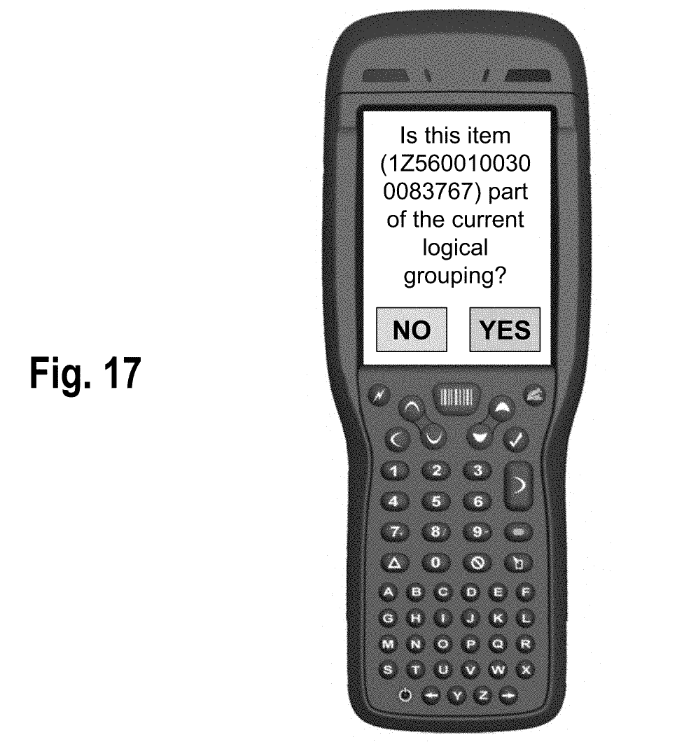

Responsive to determining that an item/shipment is not part of the current logical grouping, in one embodiment, the carrier personnel computing entity can present a customized, interactive interface to the carrier personnel (Blocks 535, 540, 545 of FIG. 5A). In one embodiment, the customized, interactive interface may provide the carrier personnel with the ability to confirm whether the item/shipment is part of a new logical grouping (see FIG. 17). Responsive to input received via the customized (Block 545 of FIG. 5B), interactive interface indicating that the item/shipment is not part of a new logical grouping, an appropriate computing entity (e.g., vehicles 100, items/shipments 103, carrier computing systems 105, carrier personnel computing entities 115, and/or the like) can automatically initiate a timer for a configurable time period/frame (e.g., 30 seconds, 2 minutes, 5 minutes, 10 minutes, and/or the like) to bypass the operations in Blocks 520-560 of FIG. 5A-Block 555 of FIG. 5A. The automated timer provides for a mechanism to limit the burden on carrier personnel with repeated requests (e.g., for each item/shipment being delivered) to confirm logical groupings in a short period of time (e.g., for every item/shipment delivered within a short period of time). Once the time period/frame of has elapsed (Block 560 of FIG. 5a), the process can return to Block 520 of FIG. 5A. Use of the automated timer also reduces processing by not checking each item that is for pick-up or delivery, but allows the processing element to be used for other processing and/or tasks.

Responsive to input received via the customized, interactive interface indicating that the item/shipment is part of a new logical grouping, an appropriate computing entity (e.g., vehicles 100, items/shipments 103, carrier computing systems 105, carrier personnel computing entities 115, and/or the like) can automatically generate notifications/messages for the new logical grouping (Block 550 of FIG. 5A). In an embodiment in which a timer is utilized, if an item/shipment is delivered during the time period/frame of the timer, the next delivery outside of the time period/frame from the logical grouping will be detected at Block 530 since the current logical grouping indicator will not have been updated since the corresponding operations have been bypassed. Thus, if items are delivered during the time period/frame of the timer, other items/shipments in the logical grouping will be detected to generate and transmit corresponding notifications.

FIG. 5B includes operations for generating notifications/messages for items/shipments associated with logical groupings (Blocks 550A, 550B, 550C, 550D, and 550E of FIG. 5B). As indicated in Block 550A of FIG. 5B, to generate notifications/messages, the items/shipments of the grouping of the item/shipment that is about to be delivered or has been delivered can be identified (Blocks 550A of FIG. 5A). In one embodiment, each logical grouping indicator is stored in association with the item/shipment identifiers corresponding to the logical grouping (see FIG. 14 and Block 550B of FIG. 5B). By storing the item/shipment identifiers in association with the logical grouping, less processing is required by the appropriate computing entities. In another embodiment, when a new logical grouping is identified, the corresponding items/shipments can be identified based on a logical grouping identifier search and/or the like. This allows for identification of the item/shipment identifiers corresponding to the logical grouping (Block 550B of FIG. 5B).

With the items/shipments identified for the new logical grouping, the corresponding item/shipment identifiers can be used to resolve to the appropriate communication preferences. To do so, each item/shipment identifier can be resolved to the corresponding item/shipment information/data. In one embodiment, the item/shipment information/data comprises the corresponding customer's customer profile identifier (see FIG. 10). The appropriate computing entity can use each customer profile identifier to access the electronic record of the customer profile that comprises the notification preferences. By accessing the customer profile using the customer profile identifier, the appropriate computing entity can generate and transmit notifications/messages to the customer in accordance with the corresponding communication preferences (Blocks 550D, 550E of FIG. 5B). In another embodiment, the item/shipment information/data comprises the corresponding customer's communication preferences (see the notification segment of FIG. 12). Based on the notification segment of the item/shipment information/data, the appropriate computing entity can generate and transmit notifications/messages to the customer in accordance with the corresponding communication preferences (Blocks 550D, 550E of FIG. 5B).

In one embodiment, the communication preferences may define where and how notifications/messages regarding such deliveries should be made. The communication preferences may also comprise time constraints for placing, generating, and/or transmitting notifications/messages within the time periods/frames identified by the customers. For example, the communication preferences might only allow the carrier system 100 transmit text notifications/messages to customers between 6:00 am-11:00 pm (based on time zones). Similarly, the communication preferences might only allow the carrier system 100 to place calls and transmit automated voice notifications/messages between 8:00 am-9:00 pm (based on time zones). And for email notifications/messages, the communication preferences might allow the carrier system 100 to generate and transmit them without time constraints.

As will be recognized, the carrier system 100 (or other computing entity) can automatically generate one or more notifications/messages providing information regarding an item to be delivered to the customer (Block 550E of FIG. 5B) in compliance with the customer's communication preferences and/or the carrier's time constraints. Similarly, the carrier system 100 (or other computing entity) can automatically transmit the one or notifications/messages to the electronic destination addresses in compliance with the customer's communication preferences and/or the carrier's time constraints. For example, the carrier system 100 may generate and transmit an email notification/message to Joseph Brown's email address and a text notification/message to Joseph's cellular phone. The notifications/messages may indicate the expected pick-up time period/frame and/or delivery time period/frame corresponding to the logical grouping. The expected pick-up time period/frame and/or delivery time period/frame may correspond to the planned time assigned to the logical grouping (e.g., 15 minutes, 1 hour, 2 hours, and/or the like, such as shown in FIGS. 18A and 18B, and a variety of other information). As will be recognized, a variety of other operations and processes may be used with embodiments of the present invention. These operations and processes can be customized to adapt to various needs and circumstances.

### 5. Initiating a Pick-Up

In one embodiment, a customer may initiate a request for pick-up of an item/shipment (e.g., pick-up request) for transportation by the carrier (Block 560 of FIG. 5C). In various embodiments, to do so, the customer (e.g., a customer or customer representative operating a consignee computing entity 110 or consignor computing entity 120) may access a webpage, application, dashboard, browser, or portal of a carrier. After the customer is identified (e.g., based on his or her profile), the customer may initiate the pick-up request. In various embodiments, the carrier system 100 may then provide a user interface (e.g., browser, dashboard, application) for the customer to provide item/shipment information/data which includes certain details regarding the requested pick-up. As previously discussed, the item/shipment information/data may include a name, street address, city, state, postal code, country, telephone number, and/or the like for both the consignor and the consignee. In various embodiments, the user interface may comprise a fillable form with fields including ship-from information/data and ship-to information/data. In various embodiments, some of the information/data fields may be pre-populated. For example, if the customer logged into a registered account/profile, the address information/data entered during registration may be pre-populated in certain information/data fields. In some embodiments, the customer may also have a digital address book associated with the account comprising address information/data for possible ship-to and/or ship-from information/data. The customer may be able to select certain ship-to and/or ship-from information/data from the address book for the associated item/shipment.

In one embodiment, after the carrier system 100 receives the ship-to and/or ship-from information/data from the customer, the carrier system 100 may perform one or more validation operations. For example, the carrier system 100 may determine whether the primary address (and/or other addresses) in the specified country or postal code is eligible for a pick-up. The carrier system 100 may also determine whether the primary address (and/or other secondary addresses) is valid, e.g., by passing the primary address through one or more address cleansing or standardization systems. The carrier system 100 may perform a variety of fraud prevention measures as well, such as determining whether the customers (or one of the delivery addresses) have been “blacklisted” from pick-up and/or delivery services. As will be recognized, a variety of other approaches and techniques can be used to adapt to various needs and circumstances.

In addition to ship-to and/or ship-from information/data, the item/shipment information/data may also include information/data regarding the item/shipment itself. For the example, the information/data regarding the item/shipment may include the number of packages, the weight and sizes of the packages, and/or the service levels. The service level options may be, for example, Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like.

In some embodiments, customers (e.g., operating a consignee computing entity 110 or consignor computing entity 120) can customize and/or provide communication preferences regarding items/shipments to be picked up (see FIG. 13). For example, the communication preferences may provide customers with the ability to request notifications/messages for items/shipments to confirm whether and when the carrier will attempt to pick up items/shipments and/or as/after items/shipments have been picked up. As will be recognized, the carrier system 100 can store communication preferences for providing information/data in association with the customer profiles and/or store the information/data in association with the item/shipment information/data. Moreover, the communication preferences may apply to the customer profile globally, to selected customer addresses, to groups of items/shipments, and/or on an item-by-item basis. In some embodiments, the carrier system 100 may allow the customer to establish preferences for the item/shipment using the user interface when the item/shipment information/data is being provided. As explained in greater detail below, these preferences may be used as notification/message criteria for determining when to send messages/notifications in association with the items/shipments being picked up.

The address information/data can also be appended with one or more customer identifiers. For example, the address information/data may be appended with one or more consignor identifiers (e.g., consignor UUIDs, GUIDs, and/or the like) and/or one or more consignee identifiers (e.g., consignee UUIDs, GUIDs, and/or the like). As will be recognized, a variety of other approaches and techniques can be used to adapt various needs and circumstances.

### 6. Identifying Facilities, Dispatch Plans, and Routes

In one embodiment, when the carrier system 100 receives a pick-up request for an item/shipment from a serviceable point, the carrier system 100 can extract/identify/determine (e.g., determine/identify) the address information/data from the item/shipment information/data (Block 562 of FIG. 5C). As shown in FIG. 11, the address information/data may include a segment identifier, an address qualifier, an address1, an address2, an address3, a city, a state or province, a postal code, a country, a GPS location (not shown), and/or the like. From the address information/data, the carrier system 100 can identify portions of the address information/data that are of interest for the pick-up request (e.g., zip code or postal code, GPS location, and/or the like).

In one embodiment, the carrier system 100 can use the address information/data of interest to identify a facility corresponding to the pick-up request (Block 564 of FIG. 5C). For instance, the carrier system 100 may identify a geographic area with which the address information/data and corresponding serviceable point are associated. For instance, from the address information/data of interest, the carrier system 100 can identify a facility that services a state or province, city, town, zip code or postal code, and/or the like. As will be recognized, a facility may be a hub, distribution center, a dispatch area, and/or the like. Each hub or distribution center may be assigned a unique facility identifier—e.g., Fulton Center=8999; Pleasantdale=2150; Doraville=8954. By way of example, if the pick-up request were for 1201 West Peachtree Street, Atlanta, Ga. 30309, the carrier system 100 may identify Fulton Center 8999 as the facility that services the address of 1201 West Peachtree Street, Atlanta, Ga. 30309 or the zip code of 30309. As will be recognized, facilities can be identified use a variety of approaches and techniques to adapt to a variety of needs and circumstances.

With the facility identified/determined from the address information/data of interest, the carrier system 100 can identity any dispatch plans associated with the facility (Block 566 of FIG. 5C). As previously described, dispatch plans are groups of routes planned to be dispatched together along with their associated delivery and pick-up assignments. Dispatch plans may also indicate how each route should be loaded. In one embodiment, a facility may have a single dispatch plan with multiple routes. In another embodiment, a facility may have multiple dispatch plans, each dispatch plan with multiple routes. In the embodiment in which a facility has multiple dispatch plans, the appropriate dispatch plan can be identified—such as by using an identifier in the address information/data, a customer identifier appended to the item/shipping information/data (e.g., UUID, GUID), address matching, a dispatch plan identifier, a route identifier, a logical grouping identifier, and/or the like.

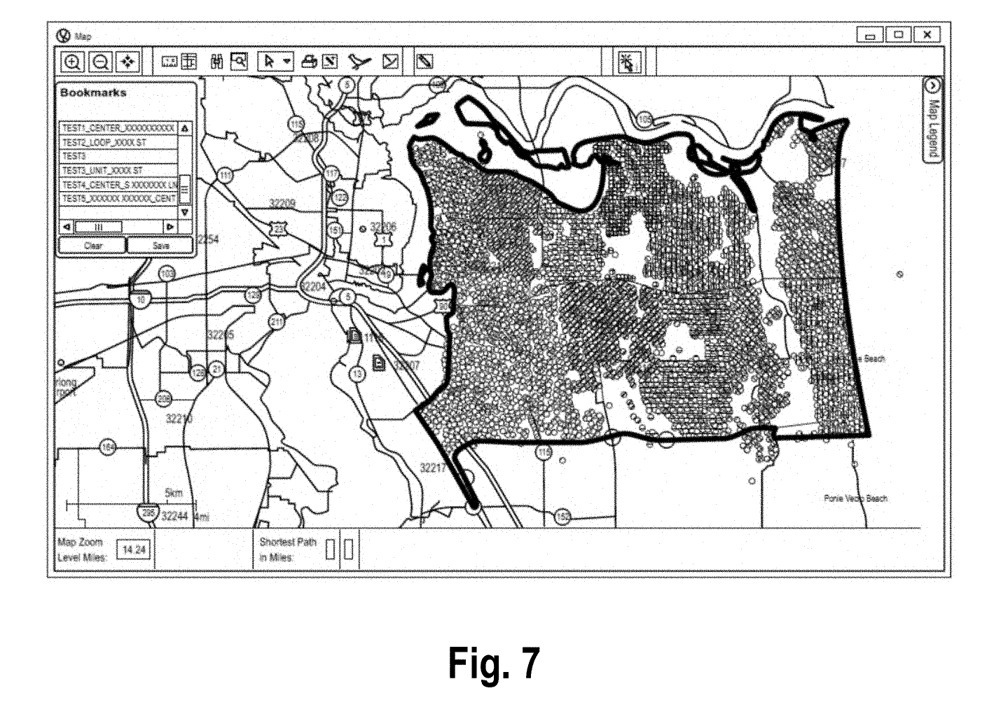

With the appropriate dispatch plan identified, the carrier system 100 can identify the route to which the pick-up request corresponds (Block 568 of FIG. 5C). That is, the carrier system 100 can identify the route to which the address is assigned. As noted, a route is generally a grouping of address ranges for serviceable points with associated service levels assigned to a single service provider (e.g., carrier delivery personnel). Routes can be dynamically updated to add, remove, or update pick-up requests and/or deliveries. FIGS. 6 and 7 show a portion of a dispatch plan with corresponding facilities and routes. In one embodiment, the appropriate route can be identified by the carrier system 100 using an identifier in the address information/data, a customer identifier appended to the item/shipping information/data (e.g., UUID, GUID), address matching, a dispatch plan identifier, a route identifier (e.g., 70D), a logical grouping identifier, and/or the like. As will be recognized, a variety of other approaches and techniques can be used to identify the appropriate route for the pick-up request to various needs and circumstances.

### 6. Confirming a Pick-Up Time Based on Logical Groupings

In one embodiment, the carrier system 100 determine whether a pick-up request can be fulfilled within a configurable time period/frame. The configurable time period/frame may be less than or equal to the planned time for the logical grouping corresponding to the pick-up request. As previously described, a logical group may comprise a plurality of items/shipments that are to be delivered within a planned time (e.g., an estimated time period/frame of one another, such as 15 minutes, 1 hour, 2 hours, 4 hours, day, and/or the like). For instance, logical groupings may be based on routes, route portions, neighborhood names, zip codes, zip code+4, geographic areas, longitude and latitude ranges, geocodes, geographic descriptors, zones of confidence, geofences, and/or the like. As will be recognized, in one embodiment, each route may comprise one or more logical groupings and/or logical grouping identifiers. Each logical grouping may correspond to a specific planned time (e.g., estimated delivery time or window). For instance, a logical grouping may be associated with planned time of 15 minutes, 30 minutes, 1 hour, 2 hours, and/or the like for delivering all of the items/shipments in the logical grouping. Similarly, the estimated pick-up time or window may indicate the estimated amount of time to pick up an item/shipment at any address associated with the logical grouping. For instance, if the planned time for the logical grouping is 1 hour, the notifications/messages can indicate that the items/shipments for the logical grouping can be picked up within the next hour from that point. That is, the estimated pick-up window or time can be used to indicate when or within what time from the corresponding items/shipments can be delivered. If the current time is 1:00 pm EST and the planned time is 1 hour, the estimated pick-up for an item/shipment that is in the logical grouping will be 1:00 pm EST to 2:00 pm EST.

As will be recognized, the logical groupings can be stored in association with the item/shipment information/data and/or a specific field or portion of a field designated as a logical grouping identifier. For example, the logical grouping identifier may be a portion of the shipment identifier (see FIG. 10), all or a portion of a zip code field (see FIG. 11), a load/storage position, a route, a route portion, all or a portion of a sequence number (see FIG. 13), a geographic descriptor, and/or the like.

As previously discussed, the user interface of carrier personnel computing entities 115 can be configured to permit driver to indicate various service dynamics, such as inputting an indication that a delivery is about to occur or has occurred. In response to receiving input indicating that a delivery is about to occur or has occurred, the carrier personnel computing entity 115 may capture service information/data and/or item/shipment information/data in a computer readable format. After receiving input capturing the service information/data and/or item/shipment information/data, an appropriate computing entity (e.g., vehicles 100, items/shipments 103, carrier computing systems 105, carrier personnel computing entities 115, and/or the like) can store an indicator of the current logical grouping based on the last item/shipment delivered. Correspondingly, each time the carrier personnel computing entity 115 (or other appropriate computing entity) records a stop as being completed (e.g., an item as being delivered), the carrier personnel computing entity 115 can store the logical grouping of that item/shipment (e.g., the most recently delivered item/shipment) as the current logical grouping.

Thus, when a pick-up request has been received and the route is determined for the pick-up request from the address information/data, the appropriate computing can determine whether the address information/data for the pick-up request is part of the current logical grouping (Block 570 of FIG. 5C). For example, the carrier system 100 can determine whether the address associated with the pick-up request is part of the current logical grouping by using an identifier in the address information/data, a customer identifier appended to the item/shipping information/data (e.g., UUID, GUID), address matching, a dispatch plan identifier, a route identifier (e.g., 70D), a logical grouping identifier, and/or the like. As will be recognized, a variety of other approaches and techniques can be used to identify the appropriate route for the pick-up request to various needs and circumstances.

In one embodiment, responsive to a determination that the address associated with the pick-up request is not part of the current logical grouping, an appropriate computing entity can generate a notification/message indicating that that pick-up request cannot be carried out within the planned time associated with the current logical grouping (Block 572 of FIG. 5C). For instance, if the planned time for the current logical grouping were 60 minutes, the notification/message may indicate that the pick-up request cannot be fulfilled by the driver of the corresponding route within the following 60 minutes. The notification/message may be displayed to a variety of different users.

In one embodiment, responsive to a determination that the address associated with the pick-up request is part of the current logical grouping, an appropriate computing entity can generate identify the planned time for the current logical grouping and generate a notification/message indicating that that pick-up request can be carried out within the planned time associated with the current logical grouping (Blocks 574, 576 of FIG. 5C). For instance, if the planned time for the current logical grouping were 60 minutes, the notification/message may indicate that the pick-up request can be fulfilled by the driver of the corresponding route within the following 60 minutes. The notification/message may be displayed to a variety of different users. Similarly, the route may be dynamically updated by the carrier system 100 to indicate when the pick-up for the pick-up request should be carried out. As previously noted, U.S. Pat. No. 7,624,024 entitled Systems and Methods for Dynamically Updating a Dispatch Plan, filed Apr. 18, 2005 provides a general description of dispatch plans and how these plans may be dynamically and updated.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
for each of a first plurality of items, electronically storing shipping data comprising (a) a first logical grouping identifier corresponding to a first logical grouping with which each of the first plurality of items is associated and (b) a respective item identifier for each of the first plurality of items;
for each of a second plurality of items, electronically storing shipping data comprising (a) a second logical grouping identifier corresponding to a second logical grouping with which each of the second plurality of items is associated and (b) a respective item identifier for each of the second plurality of items;
electronically setting a current logical grouping identifier to the first logical grouping identifier;
responsive to receiving input that a particular item from the second plurality of items is to be delivered, determining whether the logical grouping identifier for the particular item is the same as the current logical grouping identifier; and
responsive to determining the logical grouping identifier for the particular item is not the same as the current logical grouping identifier, identifying the shipping identifiers associated with the second logical grouping.

2. The method of claim 1 further comprising, responsive to determining the logical grouping identifier for the particular item is not the same as the current logical grouping identifier, electronically setting the current logical grouping identifier to the second logical grouping identifier.

3. The method of claim 1 further comprising:
for each of the second plurality of items, identifying a customer profile identifier based at least in part on the corresponding item identifier;
for each of the second plurality of items, identifying communication preferences based at least in part on the corresponding customer profile identifier; and
for each of the second plurality of items, transmitting a notification in accordance with the corresponding communication preferences.

4. The method of claim 1 further comprising:
for each of the second plurality of items, identifying communication preferences based at least in part on the corresponding item identifier; and
for each of the second plurality of items, transmitting a notification in accordance with the corresponding communication preferences.

5. The method of claim 1 further comprising, responsive to determining the logical grouping identifier for the particular item is not the same as the current logical grouping identifier, providing an interactive interface for a user to confirm that the particular item is not part of the current logical grouping.

6. The method of claim 1 further comprising:
identifying a planned time for the second logical grouping; and
determining an estimated delivery window for the plurality of items of the second logical grouping, where each notification comprises the estimated delivery window.

7. An apparatus comprising at least one processor and at least one memory including program code, the at least one memory and the program code configured to, with the processor, cause the apparatus to at least:
for each of a first plurality of items, electronically store shipping data comprising (a) a first logical grouping identifier corresponding to a first logical grouping with which each of the first plurality of items is associated and (b) a respective item identifier for each of the first plurality of items;
for each of a second plurality of items, electronically store shipping data comprising (a) a second logical grouping identifier corresponding to a second logical grouping with which each of the second plurality of items is associated and (b) a respective item identifier for each of the second plurality of items;
electronically set a current logical grouping identifier to the first logical grouping identifier;
responsive to receiving input that a particular item from the second plurality of items is to be delivered, determine whether the logical grouping identifier for the particular item is the same as the current logical grouping identifier; and
responsive to determining the logical grouping identifier for the particular item is not the same as the current logical grouping identifier, identify the shipping identifiers associated with the second logical grouping.

8. The apparatus of claim 7, wherein the memory and program code are further configured to, with the processor, cause the apparatus to, responsive to determining the logical grouping identifier for the particular item is not the same as the current logical grouping identifier, electronically set the current logical grouping identifier to the second logical grouping identifier.

9. The apparatus of claim 7, wherein the memory and program code are further configured to, with the processor, cause the apparatus to:
for each of the second plurality of items, identify a customer profile identifier based at least in part on the corresponding item identifier;
for each of the second plurality of items, identify communication preferences based at least in part on the corresponding customer profile identifier; and
for each of the second plurality of items, transmit a notification in accordance with the corresponding communication preferences.

10. The apparatus of claim 7, wherein the memory and program code are further configured to, with the processor, cause the apparatus to:
for each of the second plurality of items, identify communication preferences based at least in part on the corresponding item identifier; and
for each of the second plurality of items, transmit a notification in accordance with the corresponding communication preferences.

11. The apparatus of claim 7, wherein the memory and program code are further configured to, with the processor, cause the apparatus to, responsive to determining the logical grouping identifier for the particular item is not the same as the current logical grouping identifier, provide an interactive interface for a user to confirm that the particular item is not part of the current logical grouping.

12. The apparatus of claim 7, wherein the memory and program code are further configured to, with the processor, cause the apparatus to:
identify a planned time for the second logical grouping; and
determine an estimated delivery window for the plurality of items of the second logical grouping, where each notification comprises the estimated delivery window.

13. A computer program product comprising at least one non-transitory computer-readable storage medium having computer-readable program code portions stored therein, the computer-readable program code portions comprising:
an executable portion configured to, for each of a first plurality of items, electronically store shipping data comprising (a) a first logical grouping identifier corresponding to a first logical grouping with which each of the first plurality of items is associated and (b) a respective item identifier for each of the first plurality of items;
an executable portion configured to, for each of a second plurality of items, electronically store shipping data comprising (a) a second logical grouping identifier corresponding to a second logical grouping with which each of the second plurality of items is associated and (b) a respective item identifier for each of the second plurality of items;
an executable portion configured to electronically set a current logical grouping identifier to the first logical grouping identifier;
an executable portion configured to, responsive to receiving input that a particular item from the second plurality of items is to be delivered, determine whether the logical grouping identifier for the particular item is the same as the current logical grouping identifier; and
an executable portion configured to, responsive to determining the logical grouping identifier for the particular item is not the same as the current logical grouping identifier, identify the shipping identifiers associated with the second logical grouping.

14. The computer program product of claim 13 further comprising an executable portion configured to, responsive to determining the logical grouping identifier for the particular item is not the same as the current logical grouping identifier, electronically set the current logical grouping identifier to the second logical grouping identifier.

15. The computer program product of claim 13 further comprising:
an executable portion configured to, for each of the second plurality of items, identify a customer profile identifier based at least in part on the corresponding item identifier;
an executable portion configured to, for each of the second plurality of items, identify communication preferences based at least in part on the corresponding customer profile identifier; and
an executable portion configured to, for each of the second plurality of items, transmit a notification in accordance with the corresponding communication preferences.

16. The computer program product of claim 13 further comprising:
an executable portion configured to, for each of the second plurality of items, identify communication preferences based at least in part on the corresponding item identifier; and
an executable portion configured to, for each of the second plurality of items, transmit a notification in accordance with the corresponding communication preferences.

17. The computer program product of claim 13 further comprising an executable portion configured to, responsive to determining the logical grouping identifier for the particular item is not the same as the current logical grouping identifier, provide an interactive interface for a user to confirm that the particular item is not part of the current logical grouping.

18. The computer program product of claim 13 further comprising:
an executable portion configured to identify a planned time for the second logical grouping; and
an executable portion configured to determine an estimated delivery window for the plurality of items of the second logical grouping, where each notification comprises the estimated delivery window.
